(19) United States
(12) Patent Application Publication
(10) Pub. No.: US 2024/0420694 A1
(43) Pub. Date: Dec. 19, 2024

(54) STORAGE MEDIUM, INFORMATION PROCESSING APPARATUS, AND INFORMATION PROCESSING METHOD

(71) Applicant: KABUSHIKI KAISHA TOSHIBA, Tokyo (JP)

(72) Inventors: Nayuko WATANABE, Kawasaki (JP); Kenji IWATA, Machida (JP); Otoharu KUWAMURA, Yokohama (JP)

(73) Assignee: KABUSHIKI KAISHA TOSHIBA, Tokyo (JP)

(21) Appl. No.: 18/589,692

(22) Filed: Feb. 28, 2024

(30) Foreign Application Priority Data
Jun. 13, 2023 (JP) 2023-097228

(51) Int. Cl. G10L 15/22; G10L 15/06

(52) U.S. Cl. CPC G10L 15/22; G10L 15/063; G10L 2015/0631

(57) ABSTRACT

According to one embodiment, a non-transitory computer readable storage medium includes computer executable instructions. The instructions, when executed by a processor, cause the processor to perform a method. The method includes acquiring one or more items and information about a value of an input field for the one or more items from a recording data sheet including the input field of speech input respectively for the items; and estimating an input format of the input field based on the information.

### CROSS-REFERENCE TO RELATED APPLICATION

This application is based upon and claims the benefit of priority from Japanese Patent Application No. 2023-097228, filed Jun. 13, 2023, the entire contents of which are incorporated herein by reference.

### FIELD

Embodiments described herein relate generally to a storage medium, an information processing apparatus, and an information processing method.

### BACKGROUND

In a manufacturing or maintenance scene, the results measured by instrument, the results of visual inspection, etc. are input to a recording data sheet such as a form or a table, and the recording data sheet after the input is shared between workers or between a worker and a client in some cases. The contents to be input to the recording data sheet are determined in advance, and the worker conducts work in accordance with a work sequence and inputs obtained data to a predetermined position in the recording data sheet.

With business form software in general, a user inputs data by text. However, since it takes time to input text during work, there is a demand for inputting data using speech input. For example, there is a speech input method that enables input of a value to an item, which is being selected when a user speaks, by configuring input target items and the contents to be input to the items by an application which is not business form software, and the method further enables continuous input of values to the items by specifying, in advance upon the setting, the item which is to be subjected to input next. According to such a speech input method, by determining an input format of the values to be input by a speech recognition specialist in advance, speech input can be carried out based on the input format.

The speech input method above is usually not problematic. However, according to studies by the present inventors, there is room for improvement in a point that, if any speech recognition specialist is unavailable, it is difficult to determine appropriate input formats.

### BRIEF DESCRIPTION OF DRAWINGS

FIG. 1 is a block diagram illustrating a

configuration of an information processing apparatus according to a first embodiment.

FIG. 2 is a diagram illustrating an example of

form data according to the first embodiment.

FIG. 3 is a diagram illustrating an example of initial setting of an input sequence storage unit according to the first embodiment.

FIG. 4 is a diagram illustrating an example of a word list according to the first embodiment.

FIG. 5 is a diagram illustrating an example of an already input form according to the first embodiment.

FIG. 6 is a diagram illustrating automatic setting of an input sequence storage unit according to the first embodiment.

FIG. 7 is a diagram illustrating an example of an input format correspondence table of guidance according to the first embodiment.

FIG. 8 is a flow chart illustrating an input-sequence creation process according to the first embodiment.

FIG. 9 is a diagram illustrating an example of range selection according to the first embodiment.

FIG. 10 is a diagram illustrating an example of an alert according to the first embodiment.

FIG. 11 is a diagram illustrating another example of the alert according to the first embodiment.

FIG. 12 is a diagram illustrating an example of input format display of a form according to the first embodiment.

FIG. 13 is a diagram illustrating an example of input value example display of the form according to the first embodiment.

FIG. 14 is a diagram illustrating an example of input order display of the form according to the first embodiment.

FIG. 15 is a diagram illustrating another example of the input order display of the form according to the first embodiment.

FIG. 16 is a diagram illustrating a format estimation process (without concatenation) according to the first embodiment.

FIG. 17 is a diagram illustrating an example of format sorting rules according to the first embodiment.

FIG. 18 is a diagram illustrating format estimation (without concatenation) according to the first embodiment.

FIG. 19 is a diagram illustrating a format check process according to the first embodiment.

FIG. 20 is a diagram illustrating a speech input process according to the first embodiment.

FIG. 21 is a block diagram illustrating a configuration of an information processing apparatus according to a second embodiment.

FIG. 22 is a diagram illustrating an example of range automatic selection according to the second embodiment.

FIG. 23 is a flow chart illustrating an input-sequence creation process according to the second embodiment.

FIG. 24 is a block diagram illustrating a configuration of an information processing apparatus according to a third embodiment.

FIG. 25 is a flow chart illustrating an input-sequence creation process according to the third embodiment.

FIG. 26 is a flow chart illustrating a format estimation process (without concatenation) according to the third embodiment.

FIG. 27 is a flow chart illustrating a format check process according to the third embodiment.

FIG. 28 is a block diagram illustrating a configuration of an information processing apparatus according to a fourth embodiment.

FIG. 29 is a flow chart illustrating an operation example display process according to the fourth embodiment.

FIG. 30 is a diagram illustrating a hardware configuration example of an information processing apparatus according to a fifth embodiment.

### DETAILED DESCRIPTION

In general, according to one embodiment, a non-transitory computer readable storage medium includes computer executable instructions. The instructions, when executed by a processor, cause the processor to perform a method. The method includes acquiring one or more items and information about a value of an input field for the one or more items from a recording data sheet including the input field of speech input respectively for the items; and estimating an input format of the input field based on the information.

Hereinafter, embodiments will be described in detail with reference to drawings. In the following description, a case where an input-sequence creation process and a speech input process are executed by an information processing apparatus such as a tablet device having a speech input function will be described as an example. Note that, the information processing apparatus is not limited to a tablet device, but an arbitrary computer such as a personal computer (PC) or a smartphone with an external microphone and an external speaker can be appropriately used. Moreover, the information processing apparatus is not necessarily required to carry out the input-sequence creation process and the speech input process, but may be an apparatus which at least carries out the input-sequence creation process. Thus, a program of the input-sequence creation process and a program of the speech input process may be installed as one information processing program or may be installed as separated information processing programs. In either way, the information processing apparatus realizes the functions of the input-sequence creation process and the speech input process by executing the information processing program(s). Also, the in a case where the information processing apparatus carries out only the input-sequence creation process among the input-sequence creation process and the speech input process, a microphone may be omitted. Moreover, in the following description, a user of the input-sequence creation process will be referred to as an input sequence creator, and a user of the speech input process will be referred to as a speech input user. The speech input user and the input sequence creator may be the same individual or different individuals. Moreover, a plurality of speech input users and a plurality of input sequence creators may mutually cooperate.

### <First Embodiment>

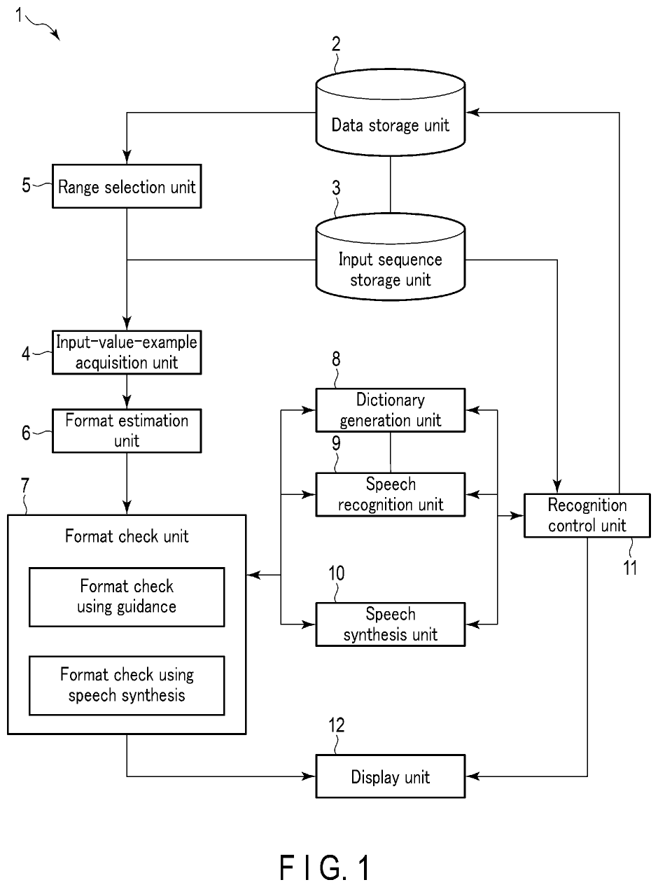

FIG. 1 is a block diagram illustrating an example of a configuration of an information processing apparatus according to a first embodiment. This information processing apparatus 1 is provided with a data storage unit 2, an input sequence storage unit 3, an input-value-example acquisition unit 4, a range selection unit 5, a format estimation unit 6, a format check unit 7, a dictionary generation unit 8, a speech recognition unit 9, a speech synthesis unit 10, a recognition control unit 11, and a display unit 12. The information processing apparatus 1 is a computer which realizes the functions of the units by executing an information processing program installed in a memory.

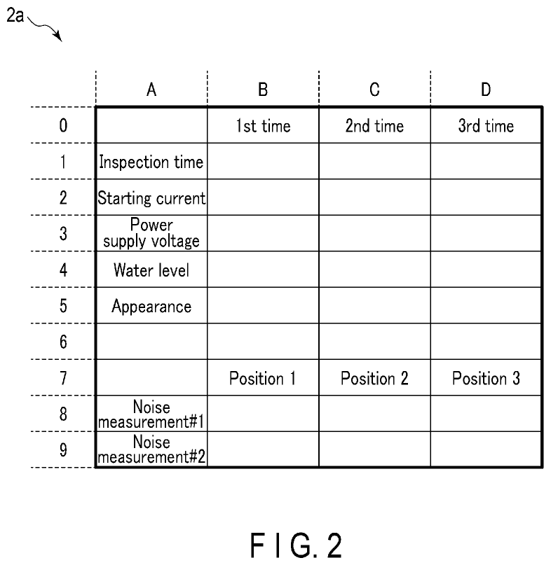

Herein, as illustrated in FIG. 2, the data storage unit 2 stores form data 2a showing data with input fields of speech input respectively for items of, for example, a form or a table. The form data 2a is an example of a recording data sheet including input fields of speech input respectively for items. For example, in the form data 2a, values are input to the input fields related to the rows represented by row numbers 1 to 5 and the items of column numbers B to D, and values are input to the input fields related to the rows represented by row numbers 8 and 9 and the items of column numbers B to D. Note that the form data 2a may be provided with a later-described word sheet as another sheet. The data storage unit 2 is an example of a memory of a computer.

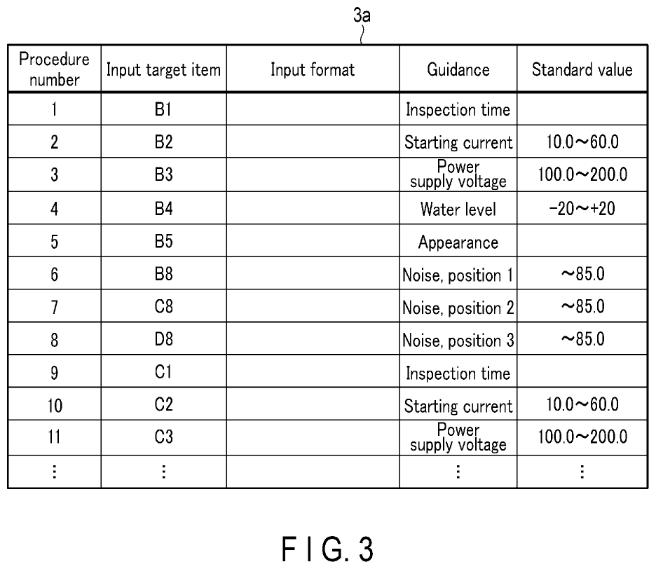

As illustrated in FIG. 3, the input sequence storage unit 3 stores input sequence 3a for inputting values in the plurality of input fields included in the form data 2a, which is the recording data sheet. The input sequence 3a includes, for example, a procedure number, an input target item, an input format, guidance, and a standard value as item names. However, the procedure numbers, the guidance, and the standard values are arbitrary additional matters and may be omitted. The input sequence 3a like this also function as a list of order for carrying out input on a plurality of items. The order of the input sequence 3a may be determined from the top to the bottom of the list, or the numbers representing the order may be separately provided as items of the input procedures. The input sequence storage unit 3 is an example of a memory of a computer. Herein, “procedure number” represents the order to input values to the plurality of input fields included in the form data 2a.

“Input target item” represents identifier which identify the input fields of the input target items included in the form data 2a. For example, if the form data is in a table format like FIG. 2, the identifier may be described as D2 by using the column number and the row number. In FIG. 3, the input sequence 3a show an example in which input is carried out on B1, B2, . . . , B5 as first measurement result input, input is then carried out on B8, C8, and D8, and input of C1, C2, . . . , C5 follows as second measurement result input.

“Input format” represents input format input format estimated by the format estimation unit 6. Note that the input sequence 3a includes an input format field in which the estimated input format can be input, and the input format estimated by the format estimation unit 6 is input in the input format field. Additionally, the input format specifies the format of the value to be input in the input field of the input target item. The later-described recognition control unit 11 creates a speech recognition dictionary based on the input formats input in the input format fields. Since it is difficult to directly describe the speech recognition dictionary in the input procedures, the input formats which are simply described are input in the present embodiment. As large categories of the input formats, for example, “Numerical values”, “Alphanumeric characters”, “Date and time”, “Date”, “Time”, “Words”, etc. can be appropriately used.

In a case of “Numerical values”, furthermore, the base thereof (decimal, hexadecimal, or the like) may be specified; and, in a case of decimal, the number of digits in the integer part thereof (range may be specified), the number of digits in the decimal part thereof, etc. may be specified.

For example, in the case of decimal, if a digit count range of the integer part is Mmin to Mmax and a digit count range of the decimal part is Nmin to Mmin, the input format is described as “Decimal_Mmin−Mmax_Nmin−Nmax”. Also, if the digit count of “Numerical value” does not have an upper limit, the input format is described as “Decimal_Mmin−_Nmin−”; and, if “Numerical value” does not have a lower limit, the input format is described as “Decimal_−Mmax_−Nmax”. Also, if the digit count of “Numerical value” does not have a range (the integer part digit count is M, and N is the decimal part), the input format is described as “Decimal_M_N”. Also, in the case of “Numerical value”, if a positive/negative sign “+ (plus)” or “− (minus)” is spoken before a numeric character, the input format is described as “[+−] Decimal_M_N”.

In the case of “Alphanumeric character”, a pattern of alphabetic characters, numeric characters, and symbols may be further specified. For example, as the pattern of the alphanumeric characters, it may be described as “A” if it is an alphabetic character, it may be described as “D” if it is a numeric character, and it may be described as “S” if it is a symbol. Moreover, as “Alphanumeric character”, “$” may be used if it is an alphabetic character or a numeric character, and the character of “!” may be used if it is an alphabetic character, a numeric character, or a symbol. For example, a pattern including three alphabetic characters, two numeric characters, one symbol, and one alphabetic character may be described as “Alpanum_AAADDSA”.

Also, in the case of “Alphanumeric character”, an optional character (character not required to be input) is described with “?”. For example, a pattern “Alphanum_AAA?DD” represents a pattern of two or three alphanumeric characters and two numeric characters. Other than this, in addition to a pattern of one character, a pattern in which a plurality of characters can be input may be described.

In the cases of “Date and time”, “Date”, and “Time”, additional specification is not particularly required. However, regarding “Date”, additional specification such as specification that which one of the date contents such as “Year/month/day”, “Month/day”, “Year/month”, and “Day” is to be input may be described. For example, a pattern “DateTime_month/day_hour/min” represents that the user can input month, date, hour, minute.

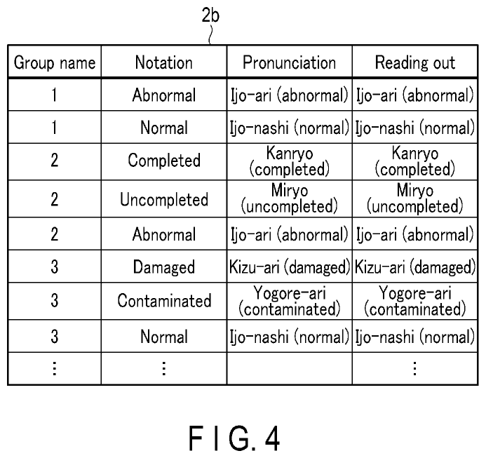

In the case of “Words”, as an example is illustrated in FIG. 4, a word list 2b is described in another sheet of the form data 2a, and group names of the word list 2b are specified. The word list 2b includes, other than the group names, notation of words, pronunciations spoken by users, and reading out (the contents read out in a case of repetition by guidance or the like). Since the word list 2b is automatically generated in the present embodiment, the group names are automatically numbered. Since only the notation of words can be acquired from an input value example, the contents of the pronunciation and the reading out are generated from the notation. The items of the pronunciation and the reading out are prepared as separated items so that the contents thereof can be changed to different contents by the input sequence creator afterward. However, the same contents may be generated and set at the stage of generation.

Note that the input formats are not limited to the above described categories, but are only required to be the input formats which enable conversion to the speech recognition dictionary and may use a combination of individual input formats. For example, as the input format, a concatenated format such as “Date_month/day, Word_day of week, (Time_hour/minute)” may be used. In such a case, after date is spoken, a word group “Day of week” (Sunday, Monday, Tuesday, . . . ) can be spoken, and time can be then spoken or not spoken. In the concatenation, () represents that the speech thereof is optional. In such a case, a recognized result is space-separated. For example, in a case of “Date_month/day, Word_day of week, (Time_hour/minute)”, “March 10 Friday 9:10”, “Mar. 11 Saturday”, or the like is obtained as a recognition result.

Moreover, for example, the input format may use OR of a plurality of input formats such as “Time_hour/minute|Time_hour/minute/second” or “Decimal_2_1|Word_abnormal/normal”. In such a case, either one of “Time_hour/minute” and “Time_hour/minute/second” may be spoken, and either one of “Decimal_2_1” and “Word_abnormal/normal” may be spoken. For example, in the case of “Time_hour/minute|Time_hour/minute/second”, “9:10”, “13:20:10”, or the like can be recognized; and, in the case of “Decimal_2_1|Word_abnormal/normal”, “12.3”, “Abnormal”, or the like can be recognized.

Also, the input format may use a combination of the above concatenated formats and OR. Also, the method of describing the input format is not limited to that described above, but is only required to be a describing method which enables conversion to the speech recognition dictionary. Note that the narrower the specified input format (a digit count range is narrow in the case of numerical values, and the number of word lists is low in the case of words), the greater the improvement in a speech recognition accuracy. However, an excessively detailed input format deteriorates usability of the speech input user since the speech contents which can be input are narrowed.

The guidance is used as the contents to be read to start each sequence in order to present work instructions in the sequence when the input sequence is actually executed to carry out speech input. Note that the guidance is not limited to the item name of the input target item, but is only required to be the guidance about speech input to the input field. For example, in a case of a inspection, the guidance includes description of instructions (guidance) about the inspection sequence. Among all the guidance, only the guidance which matches a particular pattern such as “XX time” (startup time, inspection time, and so on) is used in a subsequent input format check process.

The standard values are the values which represent a range of the acceptable values of the input field and may include any of an upper limit value, a lower limit value, or upper/lower limit values. The standard values are used to check whether the values input by speech input pass against the inspection standards or not in a case where the input sequence is actually executed to carry out speech input.

The input sequence 3a above are not limited to be retained in the input sequence storage unit 3 as the data which is separated from the form data 2a, but may be retained in the form data 2a. For example, in a general spreadsheet application, since a plurality of sheets can be included in one file, one of them may be implemented to be used for form data, and another one of them may be used for retaining input sequence. In such a case, the later-described recognition control unit 11 acquires the input sequence from the sheet for retaining the sequence. Also, in the case where the input sequence 3a are retained separately from the form data 2a, the input sequence 3a may be retained in a storage such as a database (DB) or in a memory. In the present embodiment, a sheet for retaining the input sequence is in another sheet of a file of the form data 2a. In such a case, by copying the sheet for retaining the input sequence to the file of other form data, speech input can be carried out also with the form data of the copy destination.

Note that the areas of the input sequence 3a except for the input formats may be created by manual input. For example, in a case where a sheet for retaining sequence is to be created in the file of the form data 2a, the input sequence 3a except for the input formats may be created by manually inputting a table similar to that of FIG. 3 in the sheet for retaining the sequence. Also, the input sequence 3a may be created by clicking the input target item to display a dialog and manually inputting the information, except for the input formats, in the dialog.

The input-value-example acquisition unit 4 acquires one or more item(s) and the information about the value(s) of the input field(s) corresponding to one or more item(s) from the form data 2a, which includes the input fields of speech input respectively for the items.

As the information about the value of the input field, for example, an input value example, which is an example of the value of the input field or a format configuration used to display the value of the input field can be appropriately used. In the first embodiment, the input value example is used as the information about the value of the input field. In such a case, the input-value-example acquisition unit 4 can acquire the value as the input value example from at least one of the form data 2a, in which the value(s) of the input field(s) has been input in advance, and a user interface, which receives input of a value in the input field. In the case of the form data 2a, if at least one of the input fields of the form data 2a has already been input, the input value example can be acquired from the input field. Also, the input-value-example acquisition unit 4 may acquire the information about the value of the input field to correspond to the input field of a range selected by the range selection unit 5. Note that “the information about the value of the input field” means “input hint for the input field”, “input hint information for the input field”, or the like. The input-value-example acquisition unit 4 is an example of the information acquisition unit.

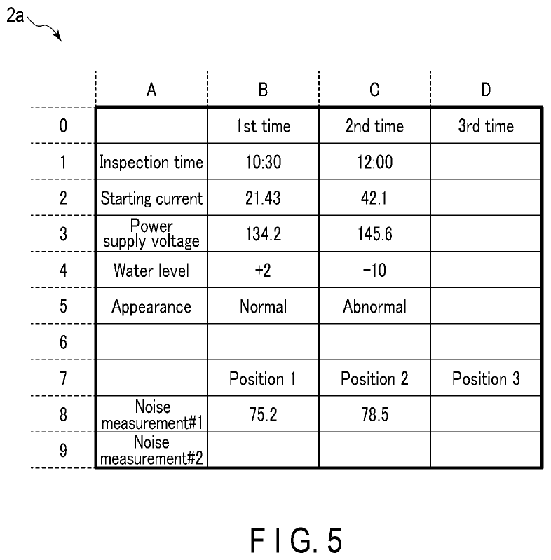

FIG. 5 illustrates an example of the already-input form data 2a. In the case of the form data 2a, as first and second measurement result values and noise measurement, only Position 1 and Position 2 of #1 are input. The input-value-example acquisition unit 4 acquires the input value examples by acquiring, with respect to the already-input form data 2a, the values of the items represented by the identifiers of the input target items of the respective input procedures. For example, with respect to the form data 2a of FIG. 5, the input value example of the input procedure of the procedure number 1 of FIG. 3 is “10:30” since the value of the input target item of the identifier B1 can be acquired. The already-input form data 2a like this may use the input value examples which are manually input before of the speech input sequence configuration, or input value examples may be newly manually input for configuration. Also, the already-input form data 2a is not limited to be singular, but may be plural. If the form data 2a is plural, a plurality of input value examples is obtained for a single input sequence. Also, if a procedure is to be configured via a user interface such as a dialog, a text box for receiving input of an input value example may be added to the dialog, and the input-value-example acquisition unit 4 may acquire the input value example by acquiring the text input in the text box.

The range selection unit 5 selects a range of a plurality of input fields from the form data 2a. More specifically, the range selection unit 5 selects a range of a plurality of input fields as a range for estimating an input format. For example, the range selection unit 5 provides a user interface for selecting a range for setting an input format. The range selection unit 5 may use the feature of an existing application, which displays forms, or may use another method.

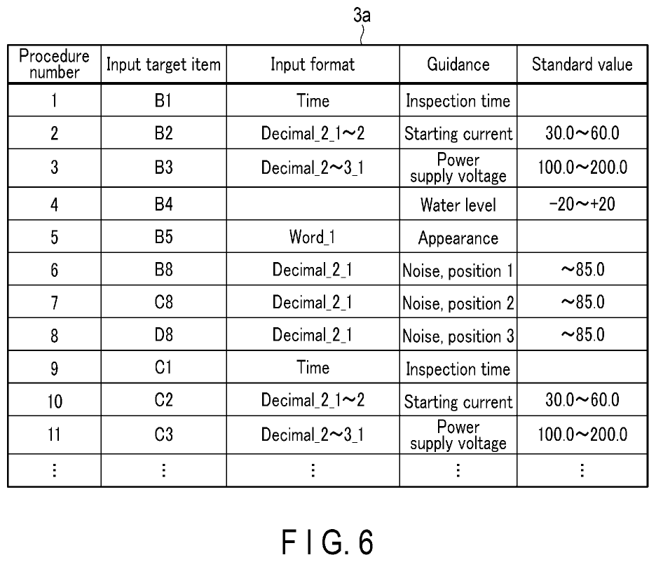

The format estimation unit 6 estimates the input format of the input field based on the input value example acquired by the input-value-example acquisition unit 4. Also, based on the input value examples acquired from the input fields of the range selected by the range selection unit 5, the format estimation unit 6 may estimate the input format, which is common to the input fields of the range. Note that the common input format is estimated from the plurality of input value examples. Also, the format estimation unit 6 may estimate the input format for each of the input fields of the range and estimate one of the input formats among the estimated input formats as the common input format. Also, the format estimation unit 6 may estimate the input format for each of the input fields of the range and estimate an input format including a plurality of the estimated input formats as the common input format. Also, the format estimation unit 6 may adjust the estimated input format based on the number of the input value examples acquired from the input fields of the selected range. Also, the format estimation unit 6 may adjust the estimated input format based on the standard values (for example, upper/lower limit values) included in the input sequence 3a. In any way, the format estimation unit 6 estimates the input formats from the input value examples and updates the input format fields of the input sequence 3a by the estimated input formats. FIG. 6 illustrates an example of the updated input sequence 3a. In this case, the input formats have already been set for the items of the input sequence 3a except for those of B4, C4, and D4.

The format check unit 7 checks validity of the estimated input format. For example, the format check unit 7 checks the estimated input format based on the guidance included in the input sequence 3a.

Also, for example, the format check unit 7 generates an input value example from the estimated input format, executes speech synthesis with the generated input value example, and executes speech recognition, by using the speech recognition dictionary, with respect to the speech data (speech waveform data) obtained by the speech synthesis. The text of the speech recognition result represents an input value example, a command for voice control, or others. Also, the format check unit 7 may check the estimated input format by judging whether the speech recognition result and the generated input value example match or not. Note that the format check unit 7 may categorize the situation of the case where the input value example and the recognition result don't match, by judging whether a voice command has been detected from the speech recognition result or not as a result of the judgement. However, the judgement about detection of the voice command may be executed not only in the case where the speech recognition result and the input value example don't match, but also in the case where the result and the value example match. Also, the format check unit 7 may check the input format by calculating the recognition accuracy or recognition error rate of the speech recognition based on the above judgement. Also, the format check unit 7 may identifiably provide a notification about the result of checking the input format. As the result of checking the input format, for example, the matching result about the recognition result and the input value example, the judgement result about false detection of the voice command, the judgement result about other false recognition, or statistical information such as a recognition error rate can be appropriately used. Also, if the command is detected, the format check unit 7 may, r, delete or change the voice command in response to operation by the use. In other words, if there is a conflict between the input value example and the voice command occurs, the format check unit 7 may solve the redundancy by deleting the command of speech input or change the word(s) of the voice command.

In any way, the format check unit 7 executes at least one of the check based on the guidance and the check using the speech synthesis and the speech recognition.

Herein, in the case of the format check based on the guidance, the guidance is set in the input sequence 3a as a precondition. The format check unit 7 checks whether there is a discrepancy between the text of the guidance and the estimated input format. For example, if the guidance is “XX time” and the input format is not a time format, it can be understood that there is a discrepancy.

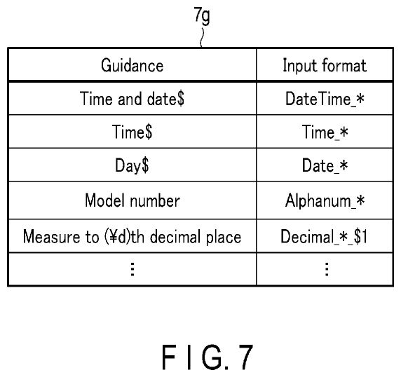

FIG. 7 illustrates an example of a rule table of conditions of the words of the guidance and the input formats corresponding thereto. In the column of the guidance, regular expressions which partially match the guidance texts are described as the conditions of the guidance. In the column of the input formats, the contents to be satisfied by the input formats in the case where the guidance match the conditions are described.

The format check unit 7 checks, for each of the input procedures corresponding to the selected range, whether the guidance text matches the guidance of the rule table in FIG. 7 or not. If there is a matched guidance row, whether the input format of the row and the estimated input format match or not is checked. If there is no matched row, the unit notifies the input sequence creator that there is no problem.

In the case of the format check using speech synthesis, the format check unit 7 checks, regarding the estimated input format, whether an input value example which is difficult to recognize by speech recognition is generated or not by speech-recognizing the speech waveform data of the input value example generated from the estimated input format.

More specifically, with respect to each input procedure, the format check unit 7 converts the text of each input value example to speech waveform data by using speech synthesis. Note that the format check unit 7 can execute the speech synthesis at arbitrary timing, for example, when a predetermined number of input value examples are generated or when predetermined operation by the user is received. Also, the format check unit 7 further applies the obtained speech waveform data to speech recognition using the speech recognition dictionary, which has been generated by the dictionary generation unit 8 for the corresponding input format. At the same time, the format check unit 7 also runs the speech recognition for command recognition used by the later-described recognition control unit 11. If the voice command detection is different from the speech recognition for an input value, the format check unit 7 recognizes an input value example using both of the two types of speech recognition. In a case where the speech recognition for the input value is also used for the speech recognition for the command recognition, the generated speech recognition dictionary is configured to include a dictionary for the command recognition, and the dictionary for the command recognition is used by the speech recognition. As a result, a speech recognition result of the generated input value example is obtained. Also, the format check unit 7 compares the speech recognition result with the generated input value example and, if it is a complete match, judges that the estimated input format is valid.

The dictionary generation unit 8 generates the speech recognition dictionary based on the estimated input format. For example, the dictionary generation unit 8 generates the speech recognition dictionary, with which speech in the input format can be recognized, based on the input formats set in the input format fields of the input sequence 3a. In this embodiment, the speech recognition dictionary describes grammar and can be uniquely generated from the input format. Also, the dictionary generation unit 8 concurrently generates the dictionary for the command recognition.

The speech recognition unit 9 is controlled by the format check unit 7 and the recognition control unit 11 and converts the speech waveform data to text by using the speech recognition dictionary. For example, in order to recognize the speech for input, the speech recognition unit 9 uses the speech recognition dictionary describing predetermined grammar. In this kind of speech recognition, the speech waveform data matching the grammar is recognized, and the speech waveform data that doesn't match the grammar is rejected. The format of the speech recognition dictionary depends on speech recognition tools, the grammar may be described in text, or the dictionary may be binary. Also, the dictionary may be in a format of an object retained in a memory. Also, the speech waveform data may be obtained from speech of the user or may be obtained by speech synthesis of text. In the present embodiment, in addition to

inputting for the items by speech, voice commands such as undoing input, proceeding to a next input procedure, and terminating input can be spoken to execute the commands. In this process, the format check unit 7 and the recognition control unit 11 run speech recognition for command recognition concurrently.

The command recognition may use the same recognition as the above described speech recognition for inputting values or may use other speech recognition. For example, instead of speech recognition using grammar, speech recognition which detects the speech of a keyword(s) included in a keyword list may be used. The speech recognition is not limited thereto, but speech recognition for general spoken language may be used. In such a case, the speech recognition dictionary is only required to have a word dictionary including notation of the words to be recognized and a grammar dictionary for judging whether to reject recognition results or not.

Note that, if the command recognition is different from the speech recognition for input for the items, the speech recognition unit 9 recognizes a generated input value example using both of the two types of speech recognition. Also, in a case where the speech recognition for input for the item is used as the command recognition, the speech recognition unit 9 uses the speech recognition dictionary including a dictionary for the command recognition.

The speech synthesis unit 10 is controlled by the format check unit 7 and the recognition control unit 11 and converts text to speech waveform data. The speech synthesis unit 10 can read aloud the text as speech by sending the speech waveform data to a speaker. The speech synthesis unit 10 is used, for example, when the validity of the input format estimated by the format check unit 7 is to be checked, when the recognition control unit 11 is to read aloud the guidance at the beginning of each input sequence, and when the contents spoken by the user are to be repeated.

The recognition control unit 11 applies speech recognition to the speech of the user using the speech recognition dictionary and inputs the text of the recognition result into the input field in accordance with the identifier, which identifies the input field of the input target item. A The recognition control unit 11 may run speech recognition using the speech recognition dictionary, which has been generated from the input format of the input procedure, and input the recognition result into the input field of the input target item of the input procedure.

For example, the recognition control unit 11 displays the form data by the display unit 12 and retrieves one input procedure from the input sequence storage unit 3 according to the order of the input procedures. The recognition control unit 11 generates the speech waveform data of guidance contents set in the input sequence using the speech synthesis unit 10. The recognition control unit 11 recognizes the user's speech by the speech recognition unit 9 using the speech recognition dictionary (and a command recognition dictionary), which has been generated from the input format set in the input procedure. If a voice command is recognized, the recognition control unit 11 executes the corresponding command. If anything other than a command is recognized, the recognition control unit 11 carries out speech synthesis with respect to the speech recognition result, repeats the contents recognized, then compares the standard value set in the input procedure with the recognition result, and, if the result is within the standard value, inputs the recognition result into the input target item. If the result falls outside the standard value, the recognition control unit 11 provides a notification about the fact by speech synthesis and, at the same time, prompts the user to speak again or forcibly carries out input.

The display unit 12 displays the data corresponding to the process of the information processing apparatus 1. For example, the display unit 12 displays the form data 2a and displays the estimated input format in the input field included in the form data 2a. Also, for example, the display unit 12 may generate one or more input value example(s) from the estimated input format and display the generated input value example(s) in the input field included in the form data 2a. Also, for example, the display unit 12 may generate a range of values, which can be input in the input field, from the estimated input format and display the generated range in the input field included in the form data 2a. Also, for example, the display unit 12 may display the form data 2a and, based on the input sequence 3a, overlay the order of inputting values in the plurality of input fields included in the form data 2a.

Specifically, for example, the display unit 12 is provided with a microphone for recording the speech of the user, a speaker for reading the speech, a display which displays stored data and various information, and a control circuit which controls the contents to be displayed by the display. The display unit 12 displays the form data 2a by the display or the like. Moreover, the display unit 12 may appropriately overlay the data in the input sequence 3a on the form data 2a. The display unit 12 may be referred to as an output unit since the display unit includes a speaker and a display or may be referred to as an input/output unit since the display unit further includes a microphone.

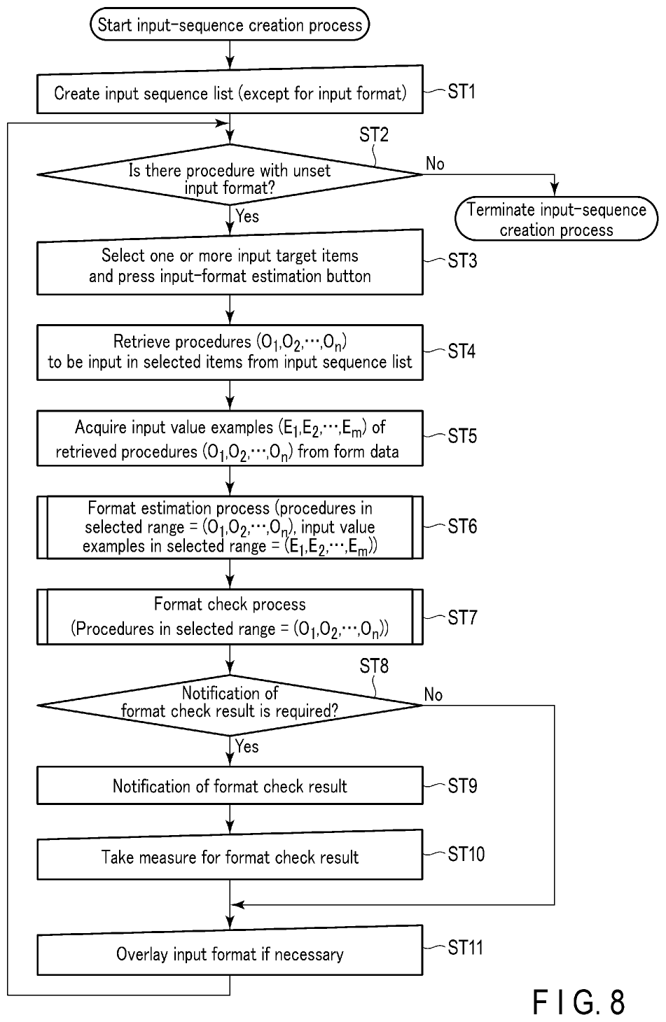

Operation of the input-sequence creation process and operation of the speech input process using the information processing apparatus built in the above described manner will be described by using FIG. 8 to FIG. 20. In the following description, the input sequence creator creates an input sequence list, except for the input formats, on partially input form data, and, then, the information processing apparatus 1 executes the input-sequence creation process and fills in the input sequence list. Also, the information processing apparatus 1 can execute the speech input process with respect to the form data which has not been input, by copying the completed input sequence list to the form data which has not been input.

### (Input-Sequence Creation Process: FIG. 8)

In step ST1, in response to operation by the input sequence creator, the information processing apparatus 1 creates an input sequence list as the input sequence 3a, which has been set except for the input format. In other words, in the input sequence 3a of step ST1, the input formats have not been set.

In step ST2, the range selection unit 5 judges whether the input sequence 3a still include a procedure for which the input format has not been set or not and, if not, terminates the input-sequence creation process. As a result of the judgement of step ST2, if there is still the input format which has not been set, the range selection unit 5 transitions to step ST3.

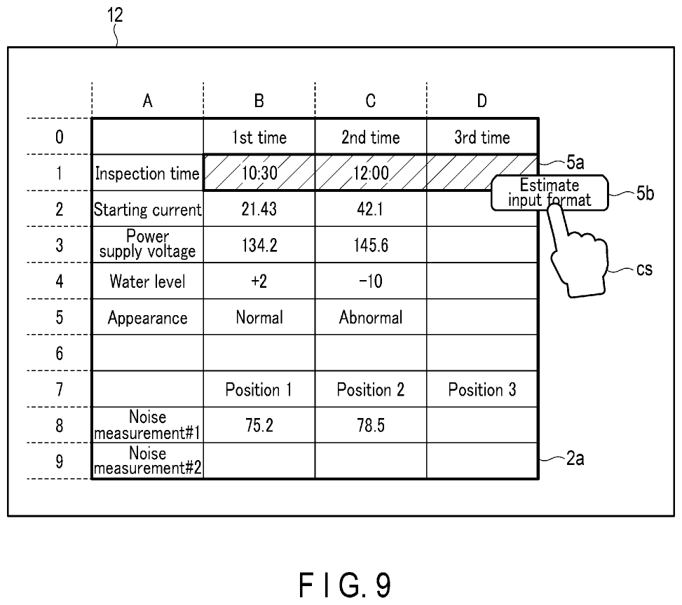

In step ST3, as illustrated in FIG. 9, in response to operation of a cursor cs by the input sequence creator, the range selection unit 5 selects a range 5a including a plurality of input fields corresponding to one or more input target items in the form data 2a and the input sequence creator presses an input-format estimation button 5b displayed. Note that the range selection unit 5 may select a range which includes only one input field.

In step ST4, the input-value-example acquisition unit 4 retrieves, from the input sequence list, procedures (O₁, O₂, . . . , Oₙ) which have the identifiers of the input fields in the selected range as input target items. Herein, n represents the number of the procedures O in the selected range. In the case of FIG. 9, the retrieved procedures (O₁, O₂, . . . , Oₙ) are the three rows (n=3) corresponding to the identifiers B1, C1, and D1 of the input fields indicated by the input target items of the input sequence 3a.

In step ST5, the input-value-example acquisition unit 4 acquires input value examples (E₁, E₂, . . . , Eₘ) of the items in the selected range from the form data 2a. Herein, m represents the number of the input value examples in the selected range. In the case of FIG. 9, the number of the retrieved input value examples (E₁, E₂, . . . , Eₘ) is two (m=2), i.e., “10:30” and “12:00”.

In step ST6, the format estimation unit 6 executes a format estimation process of estimating the input format based on the acquired procedures (O₁, O₂, . . . . Oₙ) and the input value examples (E₁, E₂, . . . , Eₘ) thereof. The input formats of the input sequence 3a are updated (set) by the result of the format estimation process. Details of the format estimation process of step ST6 will be described later.

In step ST7, the format check unit 7 executes a format check process with respect to the estimated and updated input format, judges whether a notification is required or not required, and, if the notification is required, obtains a false recognition list to be notified. Details of the format check process of step ST7 will be described later.

In step ST8, the format check unit 7 judges whether the format check result is required to be notified or not and, if not, the process proceeds to step ST11. On the other hand, if the notification is required as a result of the judgement in step ST8, the process transitions to step ST9.

In step ST9, in the case where the notification is required, the format check unit 7 notifies the display unit 12 of the false recognition list as the format check result. The display unit 12 displays the format check result.

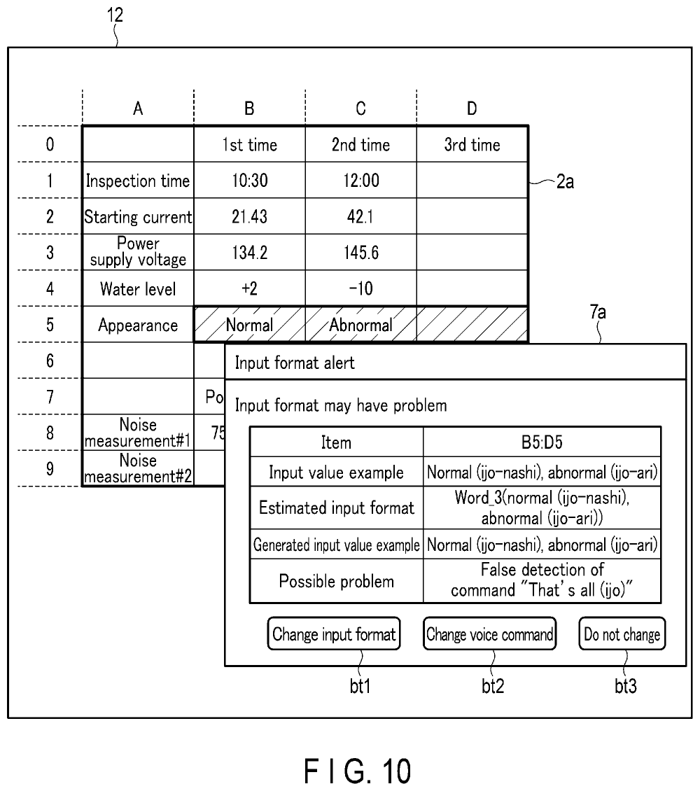

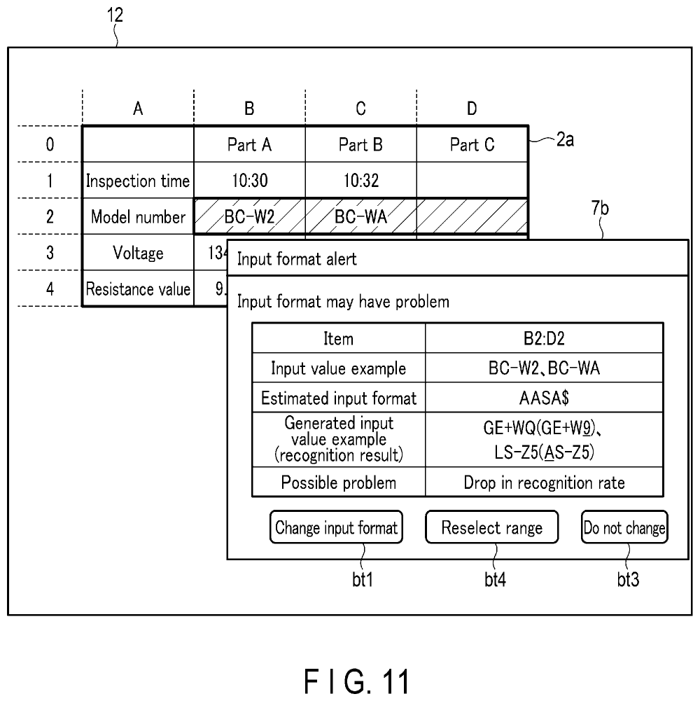

Herein, display examples including an alert in the format check result will be described by using FIG. 10 and FIG. 11.

In a case where false detection of a command occurs as a result of the speech recognition of the input value example, speaking the input value example thereof results in a situation in which the command is falsely recognized. For example, such a case is a situation in which the input value examples contains the voice command or a situation in which the command is recognized while recognizing the input value example using speech recognition dictionary for the input values and the voice commands concurrently. In any way, the display unit 12 displays the fact that “command can be falsely detected” on a screen in association with the input target item with the false detection, the input format (including a word in a word list in a case of “Word”), and the input value example. In the case of “Word” or the like, this is particularly effective since the command false detection can be prevented by changing the word to be input.

FIG. 10 illustrates the display example of providing a notification about a format check result showing command false detection by a dialog 7a. In this example, words such as “Normal (ijo-nashi)” and “Abnormal (ijo-ari)” are conflicting with a command “That's all (ijo)”, and command false detection is notified. Also, the input target item for which the false detection has occurred, and an estimated input format is also notified together. A method to display the notification contents is not limited to this. For example, the input target item with false detection may be, for example, highlighted.

In a lower part of the dialog 7a of FIG. 10, buttons bt1 to bt3 “Change input format”, “Change voice command”, and “Do not change” are displayed, and the input sequence creator can select a way to handle the possibility of command false detection by pressing any of the buttons bt1 to bt3.

If the input sequence creator presses the button bt1 showing “Change input format”, the display unit 12 prompts change of the input format, for example, by moving display to the corresponding input procedure of the sequence retaining sheet and displaying a dialog for changing the input format.

Also, if the input sequence creator presses the button bt2 showing “Change voice command”, the display unit 12 automatically changes the word of the falsely detected command. For example, a plurality of candidates are provided for each command, and, if false detection occurs, the word can be changed to another one selected from the candidates, or the word may be changed to a word having a similar meaning by referencing word2vec, thesaurus, or the like. If the input format or the voice command is changed, the format check unit 7 executes format check again and checks if a similar problem is caused or not. If the input sequence creator selects the button bt3 showing “Do not change”, the display unit 12 does not do anything.

On the other hand, even if the above-described command false detection does not occur, false recognition may occur. For example, in Japanese, both of the alphanumeric characters “9 (kyu)” and the alphabet letter “Q (kyu)” are pronounced as “kyu” and cannot be distinguished by speech. In addition, some words may be difficult to be recognized.

Therefore, the format check unit 7 may compare the speech recognition result and the generated input value example and calculate a speech recognition accuracy. Since such input value examples are not always generated, problematic examples such as “9 (kyu)” and “Q (kyu)” may be always included in input value generation. If the speech recognition accuracy is lower than a predetermined threshold value, the input sequence creator is notified of the fact as well as the case of command false detection. In addition to the fact that the recognition accuracy is low, the input sequence creator may be notified of specific parts of false recognition occurrence at the same time as details of the problem since the parts are obtained from the comparison between the speech recognition result and the generated input value example.

FIG. 11 illustrates the display example of providing a notification about a format check result showing the drop in the recognition rate by a dialog 7b. In this example, instead of the button bt2 showing “Change voice command”, a button bt4 showing “Reselect range” is displayed. The button bt4 is displayed since changing the selected range changes the input format and may suppress the false recognition if the recognition accuracy is low. In this manner, the labor hours that the speech input sequence creator spends actually speaking and checking operation can be saved by the format check unit 7. Moreover, by carrying out the alert display, the input sequence creator can be informed of the problem and prompted to make improvement.

Regarding such alert display in the case where format check is to be carried out at a time after estimation of all the input formats is finished, a selected range(s) including the problematic input format can be highlighted, and, at the same time, a dialog(s) 7a, 7b as illustrated in FIG. 10 and FIG. 11 can be displayed therebelow.

Also, the format check may be executed every time the speech input sequence creator selects a range and input format estimation. In such a case, an alert can be similarly displayed if there is a problem after the format check. A notification method of the alert is not limited to the display of the dialogs 7a, 7b, but an arbitrary method such as display on a status bar or a notification by guidance sound can be used.

Then, in step ST10, the display unit 12 takes a measure for the format check result in accordance with operation by the input sequence creator. Note that the display unit 12 may leave the format check result untouched in accordance with the operation by the input sequence creator.

In step ST11, the display unit 12 executes overlaying of the input formats/the input value examples on the form data in accordance with the operation by the input sequence creator. During the overlaying, the input sequence creator confirms if the configured input formats have problems or not and if there are any input procedures for which the input format has not been set.

For example, the display unit 12 can execute the overlaying, by displaying a menu or the like and implementing selection from the function selection in the menu.

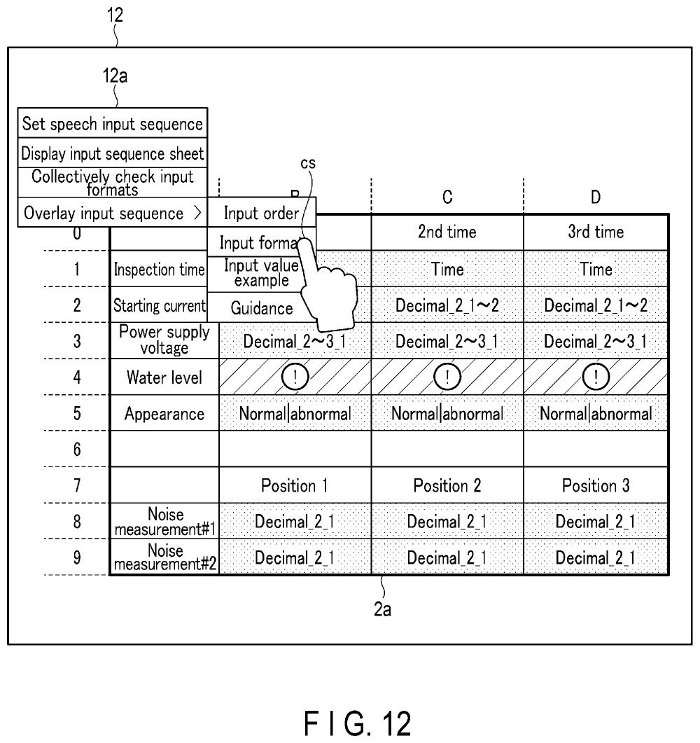

FIG. 12 illustrates a display example in which input formats in a input sequence are overlaid on the form data 2a. The display unit 12 displays a menu 12a in an upper part of the form data 2a. Input target items may be displayed, for example, with a color.

As the input formats, the contents of the input sequence 3a in the input sequence storage unit 3 may be displayed without change, or the contents of the input sequence 3a may be converted and displayed so that the input formats can be easily understood and browsed by the input sequence creator. For example, in the example of FIG. 12, the input formats of time and numerical values are displayed without change, but the input formats of words display word lists concatenated by “|” instead of group names.

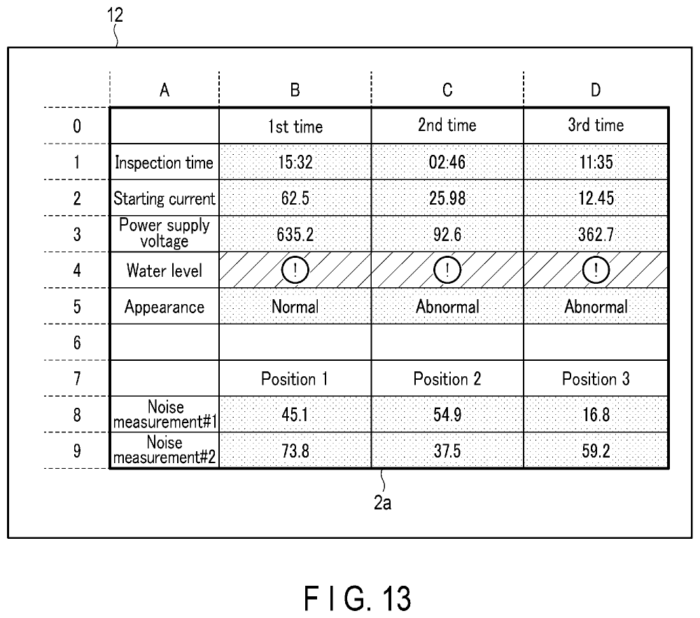

FIG. 13 illustrates an example of generating input value examples from input formats and overlaying the input value examples on the form data 2a. Since the input value examples are overlaid, the types of values to be input can be intuitively confirmed compared with a case where the input formats are displayed as is. In either case, the state that the input target items have unset input formats is understandably displayed. In the example of FIG. 13, the color of the items is changed, and icons are displayed.

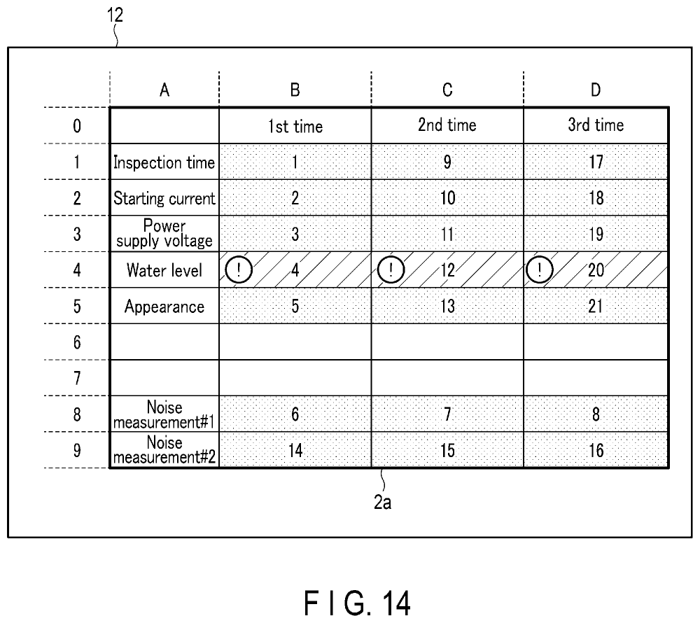

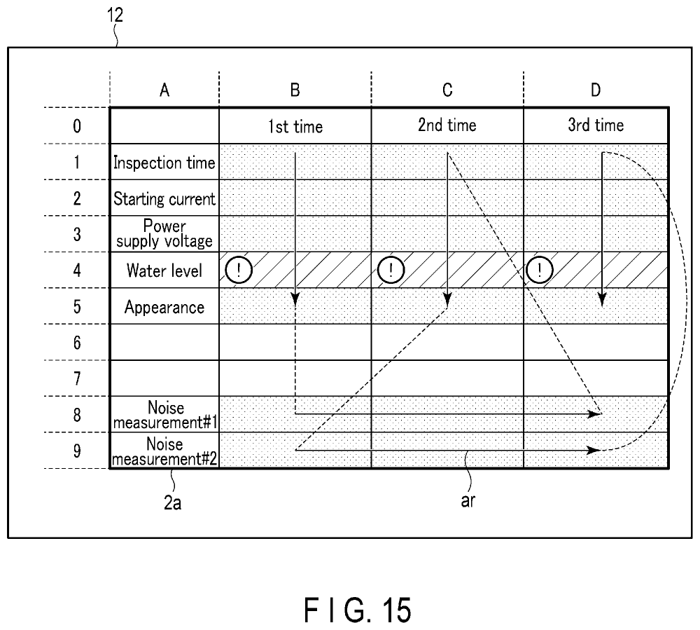

Also, other than the input formats and the input value examples, the guidance, the order of input, etc. may be overlaid so that whether the entire input sequence is correctly configured or not can be confirmed. As illustrated in FIG. 14 and FIG. 15, the order of input may be displayed by numbers, or by arrows.

After step ST11, the information processing apparatus 1 returns to step ST2 and repeatedly executes steps ST2 to ST11 until all of the input formats are set.

Next, details of the format estimation process of step ST6 will be described.

### (Details of Format Estimation Process of Step ST6)

The process of the format estimation process is changed depending on whether concatenation is allowed for the input format or not.

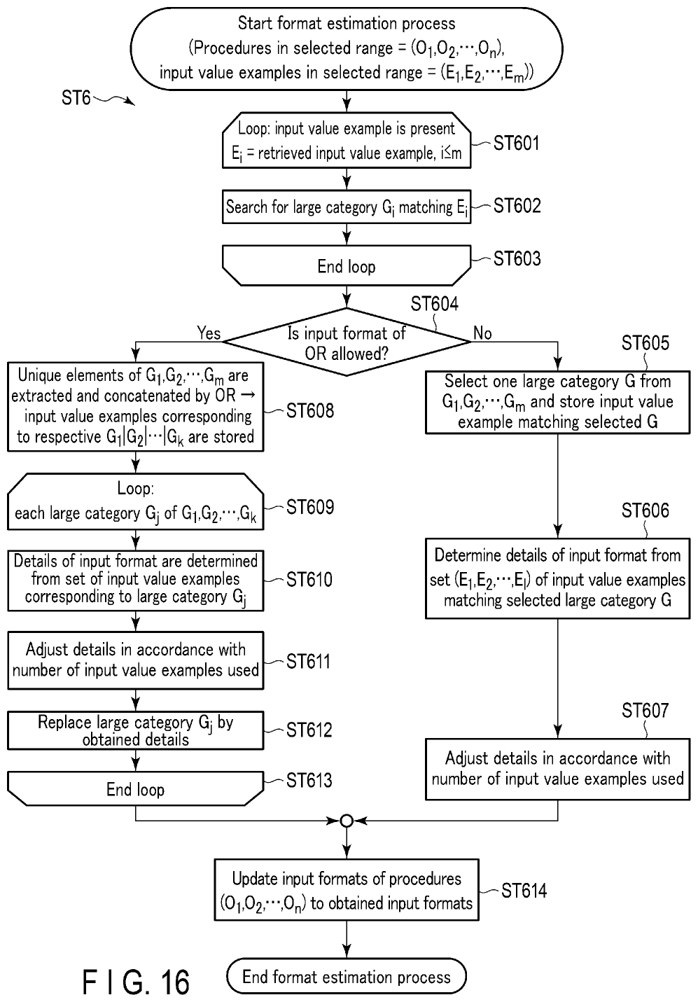

### (The Case Where Concatenation is Not Allowed: FIG. 16)

FIG. 16 illustrates a flow chart of the format estimation process in the case without concatenation.

In steps ST601 to ST603, for each of the input value examples (E₁, E₂, . . . , Eₘ) in the selected range, the format estimation unit 6 estimates a category Gᵢ of the input format which matches an input value example Eᵢ (i≤m).

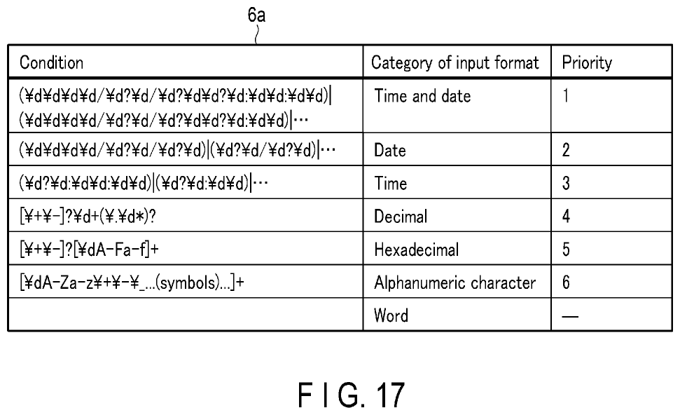

For example, if the input value example Eᵢ only includes a numerical value, a decimal point, and a sign like “−12.34”, the category seems to be a numerical value. FIG. 17 illustrates an example of such categorizing rules. In the example of the present rules, regular expressions are described as conditions. In descending order of priorities of the rule table, if the input value example Eᵢmatches the regular expression of the condition, the input value example can be considered to belong to the corresponding category Gᵢ.

If the input value example does not match any of them, the input value example Eᵢ is categorized to the category Gᵢ at the bottom which represents “Word”. For example, if the input value example Eᵢ is “2023 Mar. 7”, the input value example matches “\d\d\d\d/\d?\d/\d?\d” among the regular expressions of the conditions, and it can be found out that the input value example is “Date”. The method of categorizing is not limited to the above, and the rule is also not limited to the regular expression conditions. Also, instead of providing such rules, similar processes may be written as a program.

In step ST604, if the input format of OR is not allowed, the format estimation unit 6 proceeds to step ST605. Whether the input format of OR is allowed or not is determined in advance.

In step ST605, the format estimation unit 6 selects one category G from the categories (G₁, G₂, . . . , Gₘ) of the input formats. The format estimation unit 6 stores the input value example, which has matched the selected category G, in a memory such as the data storage unit 2.

More specifically, the case where the plurality of input value examples (E₁, E₂, . . . , Eₘ) is in the selected range includes a case where the plurality of input value examples corresponding to a plurality of items is present and a case where the plurality of input value examples corresponding to one input target item is present. In either case, the categories (G₁, G₂, . . . , Gₘ) of the input formats matching each of the input value examples have to be integrated, and one category G has to be selected.

The integration of the input formats may include all of the input formats. Also, the narrowest input format may be used, and the input value example not matching the used input format may be considered as an invalid example.

In a case where the input formats are determined to include all the input formats, if the categories are same, details of the input formats are integrated. If the categories thereof are different, the format estimation unit 6 selects the mostly used category, and the input value example not matching the category is subjected to estimation of the input format again in accordance with the selected large category thereof.

For example, an input value example “10:30” seems to be “Time”, but also can be considered as “alphanumeric character”. Therefore, if the mostly used category is “alphanumeric character”, “alphanumeric character” can be used, and a detailed format thereafter can be estimated. If there is no matching category and reestimation cannot be carried out, one large category G is selected, and the input value example not matching the category may be handled as an invalid example.

Alternatively, if OR of the input format is used as the input format, a result connected by OR may be used as an estimation result of the category.

In step ST606, regarding the selected category G, the format estimation unit 6 estimates and integrates details of the input format of each of the input value examples (E₁, E₂, . . . , Eₘ) matching the category G.

More specifically, once the category G is determined, details of the input format are estimated by using the corresponding input value example for each category G. For example, if the category G is “Numerical value (decimal)”, details such as if there is a sign like + or −, the number of the characters before the decimal point (in other words, the number of digit(s) of the integer part), and the number of the characters after the decimal point (in other words, the number of digit(s) of the decimal part) are determined.

Also, if the category G is “alphanumeric character”, a pattern of alphanumeric characters can be obtained by replacing each character by “A” if it is an alphabetic character, by “D” if it is a numeric character, and by “S” if it is another symbol.

If the category G is “Word”, the input value example is used as notation of the word without change. For example, a new group is added to the word list 2b illustrated in FIG. 4, a new name is set as a group name, and the input value example is set as the notation of the word. The contents of the pronunciation and the reading out are automatically generated and set. The detailed input format may be “Word_(group name)”.

In step ST607, the format estimation unit 6 adjusts the details of the input formats in accordance with the number of the used input value examples (E₁, E₂, . . . , Eₘ). As a result, one input format is obtained.

More specifically, the details estimated for each of the input value examples are integrated for each of the categories. The integration of the details of the input formats in the case where the input format is determined to include all of the input formats is carried out, for example, in a following manner.

In a case of a numerical value, for example, if the category is “Numerical value (decimal)” and if the estimated individual input formats are

“Decimal_3_2 (integer part: three digits, decimal part: two digits) and “Decimal_3_1” (integer part: three digits, decimal part: one digit), the decimal part may be one digit or two digits. Therefore, the integrated input format becomes “Decimal_3_1-2” (integer part: three digits, decimal part: one to two digit(s)).

In a case of alphanumeric characters, for example, if the category is “alphanumeric character” and if the estimated individual input formats are “Alphanum_AAADDSA” and “Alphanum_AADDDS”, the third character may be an alphabetic character or a numeric character, and the last alphabetic character is not always required. Therefore, the integrated input format becomes “Alphanum_AA$DDSA?).

In a case of a word, for example, if the category is “Word” and if the estimated individual input formats are “Word_1” and “Word_2”, a new group integrating groups of word lists is created, and the input formats use the group. More specifically, a new group “3” integrating a word list of a group “1” and a word list of a group “2” is created, and all of the words of “1” and the words of “2” are added to the word group “3”. The integrated format uses “Word_3”. In this process, if the input format referencing the word group “1” or “2” no longer exists, the words of the groups “1” and “2” are removed from the word list 2b.

As a result of carrying out integration in this manner, final input format details are obtained. Note that the integration method is not limited to this, but a majority may be taken, and one input format with the greatest number may be selected.

On the other hand, if OR of the input format is allowed in step ST604, the format estimation unit 6 proceeds to step ST608.

In step ST608, the format estimation unit 6 extracts OR of the categories. For example, the format estimation unit 6 extracts unique elements of (removes redundancy from) the categories (G₁, G₂, . . . , Gₘ) of the input formats and concatenates the obtained categories by OR, thereby obtaining OR large categories G₁|G₂| . . . |Gₖ (k≤m). Also, the format estimation unit 6 stores the input value examples corresponding to the respective categories Gⱼ of the OR categories G₁|G₂| . . . |Gₖ in a memory such as the data storage unit 2 (j≤k).

After step ST608, the format estimation unit 6 executes a loop process for each of the categories Gⱼ, which serves as an OR element, from step ST609 to step ST613. The loop process includes steps ST610 to ST611 similar to those described above and step ST612.

In step ST610, for the category Gⱼ, the format estimation unit 6 determines details of the input format from the corresponding input value example. Note that step ST610 is executed in a manner similar to step ST606.

In step ST611, the format estimation unit 6 adjusts the details of the input formats in accordance with the number of the used input value examples. Note that step ST611 is executed in a manner similar to step ST607.

In step ST612, the format estimation unit 6 replaces the category Gⱼ, which corresponds to the input value example, by the details of the input format. As a result, one input format corresponding to the category Gⱼ is obtained. The above loop process of steps ST609 to ST613 are executed for each category Gⱼ.

After step ST607 or ST613, in step ST614, the format estimation unit 6 updates (sets) the input format of each of the procedures (O₁, O₂, . . . , Oₙ) of the input procedures 3a to the obtained input format.

Note that if the range selected by the user with the range selection unit 5 is small and if there are not many input value examples, determining the input format only with the input value examples can make the input format too detailed. As described above, too detailed input format can deteriorate usability of the speech input user. For example, if only one input value example “12.34” is provided, the input format thereof becomes “Decimal_2_2”.

However, depending on the speech input user, a numerical value such as “12.3” omitting “0” of “12.30” may be spoken. This is not problematic if the input value example includes “12.30” and “12.3”, but that is not always the case. On the other hand, there is also a case where only “12.3” is provided as the input value example, but input of “12.30” is also actually needed.

In order to mitigate such examples, in a case where only a few input value example(s) are acquired in the selected range, the input format may be loosened. More specifically, in a case of decimal, values having digit counts with one less digit or more digit can be also included (for example, “Decimal_M_N”→“Decimal_(M−1)−(M+1)_(N−1)−(N+1)”). In a case of alphanumeric character, a pattern part including an alphabetic character(s) only can be replaced by a pattern of an alphanumeric character (for example, “Alphanum_AAA”→“Alphanum_$$$”).

After the input format is estimated in the above described manner, the input format of the currently focused input procedure (the input procedure having the range-selected items as input target items) is updated.

As a result, the format estimation process of step ST6 in the case where concatenation is not allowed is terminated.

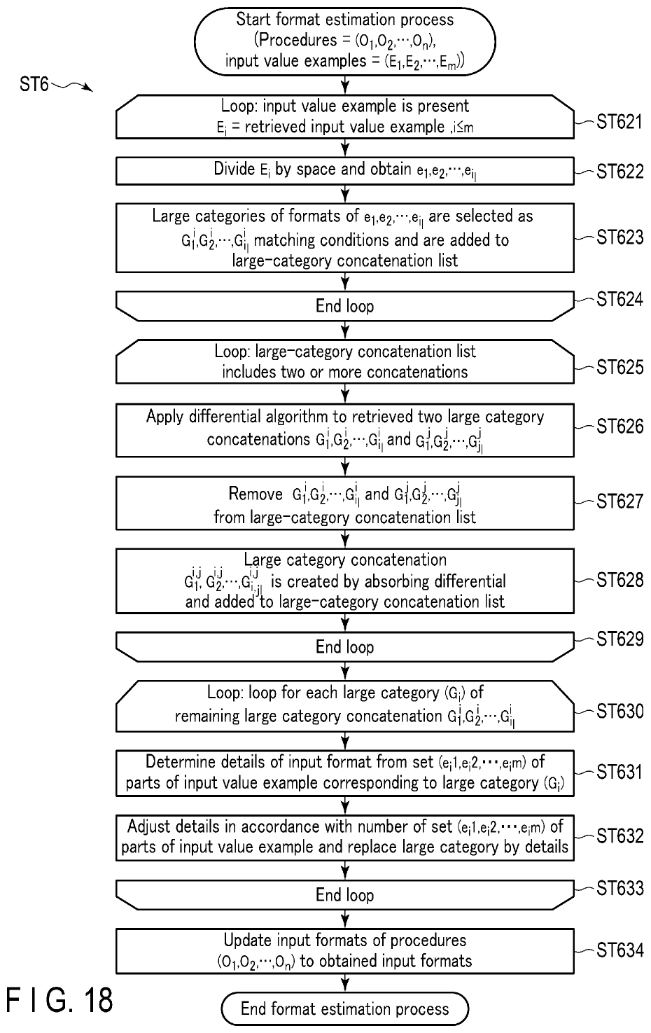

### (The Case Where Concatenation is Allowed: FIG. 18)

FIG. 18 illustrates a flow chart of the format estimation process in the case with concatenation.

In steps ST621 to ST624, the format estimation unit 6 executes a loop process for each of the input value examples (E₁, E₂, . . . , Eₘ) of the selected range. The loop process includes steps ST622 to ST623.

In step ST622, the format estimation unit 6 divides the input value example Eᵢ by space and obtains parts e₁, e₂, . . . , eᵢ₁ of the input value example Eᵢ. The subscript character “i1” represents the number of the parts e included in the input value example Eᵢ. For example, if the input value example Eᵢ is divided into three, i1=3.

In step ST623, the format estimation unit 6 selects categories G₁ⁱ, G₂ⁱ, . . . , Gᵢ₁ⁱ respectively matching the parts e₁, e₂, . . . , eᵢ₁ of the input value example Eᵢ.

More specifically, in the case where not only simple “Numerical value”, “Word”, etc., but also combinations thereof (concatenation and OR) are allowed as input formats, first, the input value example Eᵢ is separated by space, and the categories G₁ⁱ, G₂ⁱ, . . . , Gᵢ₁ⁱ respectively matching the individual parts e₁, e₂, . . . , eᵢ₁ are searched for.

For example, if the input value example Eᵢ is “2023 Mar. 7 Tue 13:00”, the part e₁ “2023 Mar. 7” matches the category G₁ⁱ of “Date”, the part e₂ “Tue” matches the category G₂ⁱ of “Word”, and the part eᵢ₁ “13:00” matches the category Gᵢ₁ⁱ of “Time”. If there is one input value example, the category having the highest priority among the plurality of categories can be selected. Thereafter, a detailed format can be estimated for each category in a manner similar to that described above.

In step ST624, the format estimation unit 6 adds concatenations of the selected categories G₁ⁱ, G₂ⁱ, . . . , Gᵢ₁ⁱ to a category concatenation list. For example, “Date, Word, Time” concatenating “Date”, “Word”, and “Time” is added to the category concatenation list. As the parts of the input value example Eᵢ corresponding to the separated parts of the category concatenation G₁ⁱ, G₂ⁱ, . . . , Gᵢ₁ⁱ, the part e₁ “2023 Mar. 7” is obtained from “Date”, the part e₂ “Tue” is obtained from “Word”, and the part eᵢ₁ “13:00” is obtained from “Time”. Note that “category concatenation” is not always required to be concatenated and therefore may be referred to as “combination of large categories”.

The format estimation unit 6 executes the loop process of steps ST621 to ST624 so as to repeat the above process by the number of the input value example(s) Eᵢ.

Then, in steps ST625 to ST629, if the category concatenation list includes two or more concatenations, the format estimation unit 6 executes a loop process. The loop process includes steps ST626 to ST628.

For example, if a plurality of input value examples is present, the contents of the large category concatenations may be different among the input value examples. For example, if the input value examples are “A12C black 12.3”, “A12M white 45.6”, and “B23F red”, there are three candidates for the large category concatenations, i.e., “Hexadecimal, Word, Decimal”, “Alphanumeric characters, Word, Decimal”, and “Hexadecimal, Word”. With respect to these, the large categories are selected to maximize matching as much as possible.

In step ST626, the format estimation unit 6 retrieves two category concatenations from the category concatenation list. Also, the format estimation unit 6 applies a ‘diff’ algorithm to the retrieved two category concatenations (G₁ⁱ, G₂ⁱ, . . . , Gᵢ₁ⁱ), (G₁^{j}, G₂^{j}, . . . , Gⱼ₁^{j}).

Two concatenation sequence of the candidates can be retrieved from the category concatenation list and considered as a difference detection problem including OR in a subsequence, and the arrangement of the categories can be determined by using an existing diff algorithm. Note that, as the diff algorithm, for example, an algorithm used in the ‘diff’ tool, etc., which finds differential parts between arrays by calculating edit distances, a longest common subsequence (LCS), and shortest edit script (SES) can be appropriately used.

As a result of the diff algorithm, any of “unchanged”, “addition”, “deletion”, and “replacement” is obtained for each character. The diff algorithm is used by treating the categories (or OR thereof) as characters, and the one with a shortest edit distance is selected.

The replacement cost between the categories may be zero if either one is included in the other one (in other words, they are considered to be the same, for example: “Decimal|Alphanumeric character” and “Alphanumeric character”, “Hexadecimal” and “Alphanumeric character”) and may be one if neither one is included in the other one.

Also, if the diff algorithm is applied to two large category concatenations “Hexadecimal, Word, Decimal” and “Alphanumeric character, Word, Decimal”, “replacement of hexadecimal and alphanumeric character, word, decimal” is obtained as differential information.

Also, in step ST627, the format estimation unit 6 deletes the two retrieved category concatenations (G₁ⁱ, G₂ⁱ, . . . , Gᵢ₁ⁱ), (G₁^{j}, G₂^{j}, . . . , Gⱼ₁^{j}) from the category concatenation list.

In step ST628, the format estimation unit 6 absorbs the difference by using the differential information obtained as a result of applying the diff algorithm and creates one category concatenation (G₁^{i,j}, G₂^{i,j}, . . . , G_{i,j1}^{i,j}).

With respect to the above described differential information “replacement of hexadecimal and alphanumeric character, word, decimal”, the format estimation unit 6 converts the part of “replacement”, “addition”, and “deletion” to a combination of categories. For example, the replacement part of “replacement of hexadecimal and alphanumeric character, word, decimal” is adjusted to use the wider one of the inclusion relation part, and “Alphanumeric character, Word, and Decimal” is obtained. In this manner, “replacement of XX and YY (XX is included by YY)” having an inclusion relation can be changed to “YY”.

If “replacement of XX and YY” with no inclusion relation appears, OR can be used, in other words, “XX|YY” can be used.

Meanwhile, “addition of XX” or “deletion of YY” can be optional large categories, in other words, “(XX)” or “(YY)”.

In this process, the information about which part of which input value example matches which large category is recorded.

Then, the format estimation unit 6 adds the created category concatenation (G₁^{i,j}, G₂^{i,j}, . . . , G_{i,j1}^{i,j}) to the category concatenation list.

The format estimation unit 6 executes the loop process of steps ST625 to ST629 so as to repeat the above process until only one category concatenation is finally left.

Then, in steps ST630 to ST633, the format estimation unit 6 executes a loop process with respect to each category Gᵢ of the remaining category concatenation (G₁ⁱ, G₂ⁱ, . . . , Gᵢ₁ⁱ) so as to obtain details of the input formats. The loop process includes steps ST631 to ST632.

In step ST631, according to a set (eᵢ₁, eᵢ₂, . . . , eᵢₘ) of the parts of the input value example Ei corresponding to the category Gᵢ, the format estimation unit 6 determines details of the input format.

In the case of the above described example, the concatenation of the remaining category Gᵢ becomes “Alphanumeric character, Word, (Decimal)”. Herein, the input value examples Eᵢ matching the category Gᵢ “Alphanumeric character” are “A12C”, “A12M”, and “B23F”, the input value examples Eᵢ matching the category Gᵢ “Word” are “black” and “white”, and the input value examples Eᵢ matching the category Gᵢ “Decimal” are “12.3” and “45.6”. Then, for each category Gᵢ, a detailed format can be estimated from the input value example Eᵢ matching the category. In the above-described example, “Alphanum_ADDA, Word_1, (Decimal_2_1)” is finally obtained, and a word list of Word_1 includes “black” and “white”.

In step ST632, the format estimation unit 6 adjusts details by the number of the set (eᵢ₁, eᵢ₂, . . . , eᵢₘ) of the parts of the input value example Eᵢ (the number of the input value examples Eᵢ used). Then, the format estimation unit 6 replaces the category Gᵢ by the obtained details.

The format estimation unit 6 executes the loop process of steps ST630 to ST633 so as to repeat the above process for each category Gᵢ.

In step ST634, the format estimation unit 6 sets the input formats obtained in the above described manner as the input formats of the corresponding plurality of input procedures. Note that, in step ST634, if there is only a few input value example, the input formats may be loosened as well as step ST614. In any way, thus, the format estimation process of step ST6 in the case where concatenation is allowed is terminated.

### (Format Check Process)

In the following format check process, the format check using speech synthesis will be described. As described with the format check unit 7, the format check process generates the input value example from the input format, generates speech waveform data by speech synthesis, carries out speech recognition by using the speech recognition dictionary generated from the input format, and carries out format check depending on whether false recognition occurs or not.

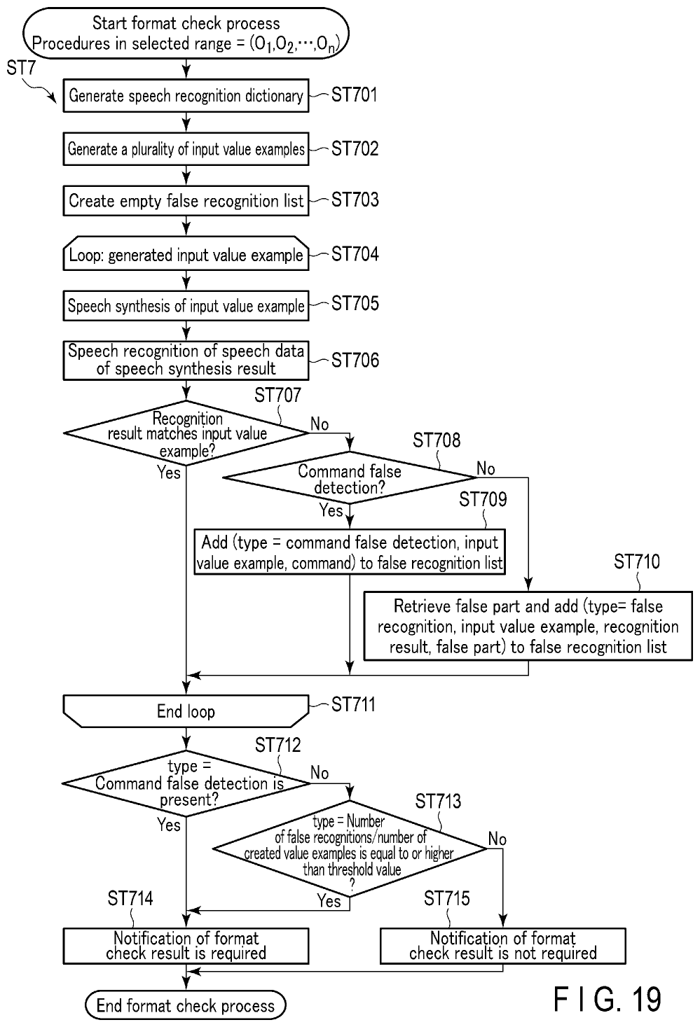

FIG. 19 illustrates a flow chart of the format check process.

In step ST701, the format check unit 7 generates the speech recognition dictionary from the focused input format by the dictionary generation unit 8.

In step ST702, the format check unit 7 generates a plurality of input value examples from the estimated input format. For example, among the parts of the input value examples which can be generated from the input format, the format check unit 7 may select candidates randomly. For example, in a case of “Numerical value”, if the input format is “Decimal_2-4_1”, the digit count of the integer part of the input value example is selected from 2 to 4 randomly, and the numeric character of each digit can be determined to 0 to 9 randomly (wherein, a top digit number is 1 to 9).

Also, in a case of “alphanumeric character”, if the input format is “Alphanum_AA$D?”, one character is selected from “A-Za-z” as a first character and a second character of the input value example, one character is selected from “A-Za-z0-9” as a third character, and whether to include or not include a fourth character is determined randomly. If the forth character (number “D”) is included, one character can be selected from “0 to 9”. Also for other large categories, a plurality of input value examples can be similarly generated randomly.

In step ST703, the format check unit 7 creates an empty false recognition list. The false recognition list is a list including false recognition types, input value examples, and detail information. As the types of false recognition, for example, command false detection and false recognition can be appropriately used. As the detail information, for example, if the type is command false detection, the corresponding command can be used. Also, for example, if the type is false recognition, as the detail information, for example, a recognition result and false part can be appropriately used.

Then, in steps ST704 to ST711, the format check unit 7 executes a loop process so as to carry out format check by speech recognition with respect to each of the generated input value examples. The loop process includes steps ST705 to ST710.

In step ST705, for each of the generated input value examples, the format check unit 7 carries out speech synthesis and obtains speech data as a speech synthesis result.

In step ST706, the format check unit 7 applies the speech recognition to the speech data of the speech synthesis result by using the generated speech recognition dictionary. Herein, the format check unit 7 carries out speech recognition of the input value example and command speech recognition concurrently. As the speech recognition dictionary, a first dictionary for input value examples and a second dictionary for commands may be used. In the case where the first and second dictionaries are used, the format check unit 7 separately executes the speech recognition of the input value example and the command speech recognition. Alternatively, as the speech recognition dictionary, a dictionary for both of input value examples and commands may be used. In the case where the dictionary for both of them is used, the format check unit 7 executes the speech recognition of the input value example and the command speech recognition at the same time. Note that, recognition results of step ST706 includes three cases, i.e., (1) a case where the input value example is recognized, (2) a case of false recognition where a command is falsely detected instead of recognizing the input value example, and (3) a case of false recognition other than command false detection. In the above described case of (1), the speech recognition has succeeded. In the above described case of (2) or (3), the speech recognition has failed. Also, the above described case of (2) where the command is falsely detected, in other words, the case where the command is obtained as a recognition result means that speaking the input value example results in false recognition of the command.

In step ST707, the format check unit 7 judges whether the text of the speech recognition result matches the input value example or not. If they match, the speech recognition has succeeded, and the process therefore proceeds to step ST711. Also, if they don't match, the speech recognition has failed, and the process therefore transitions to step ST708.

In step ST708, the format check unit 7 judges whether a reason for the failure of the speech recognition is command false detection or not. If the reason is command false detection, the process transitions to step ST709. If it is not command false detection, the process transitions to step ST710. In the case where the speech recognition has failed in step ST707, step ST708 enables categorizing the situation whether it has been a failure by command false detection or not.

In step ST709, since a command is obtained as the speech recognition result, the format check unit 7 adds the information about the command false detection to the false recognition list and proceeds to step ST711.

In step ST710, since the recognition result of the speech recognition is false recognition other than command false detection, the format check unit 7 adds the information about the false recognition to the false recognition list and proceeds to step ST711.

In step ST711, after the process of steps ST705 to ST710 is carried out for all of the generated input value examples, the format check unit 7 terminates the loop process of steps ST704 to ST711.

In step ST712, the format check unit 7 judges whether the false recognition list has the information of command false detection or not. If the list has the information of the command false detection, the process proceeds to step ST714. If the list does not have the information, the process transitions to step ST713.

In step ST713, the format check unit 7 calculates the recognition error rate by dividing the number of false recognitions in the false recognition list by the number of the input value examples and judges whether the recognition error rate is equal to or higher than a threshold value. As a result of the judgement, if the recognition error rate is equal to or higher than the threshold value, the format check unit 7 transitions to step ST714. If not, the format check unit transitions to step ST715.

In step ST714, since a notification of the format check result is required as the information of the command false detection is present or the recognition error rate is high, the format check unit 7 notifies the display unit 12 of the false recognition list corresponding to the format check result and terminates the process.

In step ST715, since the notification of the format check result is not required as the false recognition list is empty or the recognition error rate is low, the format check unit 7 terminates the process.

### (Speech Input Process)

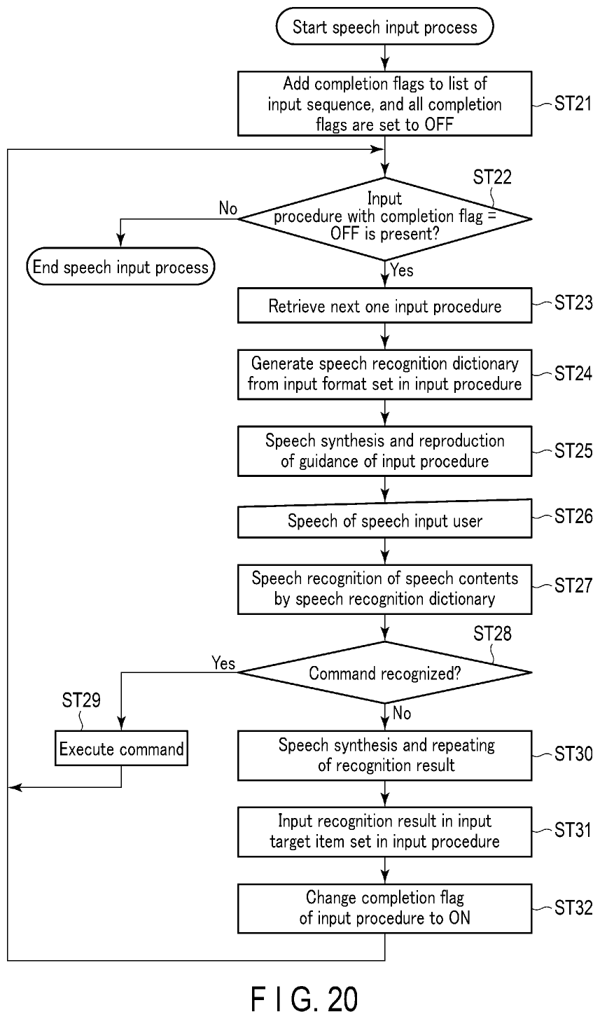

Based on the input sequence 3a obtained by the input-sequence creation process, the information processing apparatus 1 executes the speech input process together with another speech input user as illustrated in FIG. 20.

In step ST21, the recognition control unit 11 of the information processing apparatus 1 adds a flag indicating whether it has been completed or not (=completion flag) to each of the procedure numbers of the input sequence 3a and sets all of the completion flags to OFF.

In step ST22, the recognition control unit 11 judges whether or not there is the procedure number whose completion flag is OFF in the input sequence 3a, and if not, the recognition control unit terminates the speech input process. On the other hand, as a result of the judgement of step ST22, if the procedure number with the completion flag OFF is remaining in the input sequence 3a, the recognition control unit 11 transitions to step ST23.

In step ST23, the recognition control unit 11 retrieves, from the input sequence 3a, the input procedure corresponding to the row of the earliest procedure number among the procedure numbers with the completion flag OFF.

In step ST24, the dictionary generation unit 8 generates a speech recognition dictionary from the input format set in the input procedure retrieved according to the control by the recognition control unit 11.

In step ST25, the speech synthesis unit 10 synthesizes the guidance sound, which is included in the retrieved procedure, to speech synthesis according to the control by the recognition control unit 11 and reads the obtained speech waveform data by the speaker.

In step ST26, the speech recognition unit 9 waits for speech of the speech input user according to the control by the recognition control unit 11. In this process, the speech input user appropriately speaks.

In step ST27, the speech recognition unit 9 carries out speech recognition with respect to the speech of the speech input user by using the speech recognition dictionary according to the control by the recognition control unit 11.

In step ST28, the recognition control unit 11 judges whether a command is detected or not as a result of the speech recognition. If the command is detected, the process transitions to step ST29. If not, the process transitions to step ST30.

In step ST29, the recognition control unit 11 executes the recognized command and returns to step ST22.

In step ST30, the recognition control unit 11 speech synthesizes the text of the recognition result not including the command and reads the obtained speech waveform data by the speaker. As a result, the speech contents of the speech input user are repeated by the speaker.

In step ST31, the recognition control unit 11 inputs, the value represented by the text of the recognition result into the input field of the form data 2a based on the identifier of the input target item included in the retrieved procedure.

In step ST32, the recognition control unit 11 changes the completion flag of the procedure to ON and returns to step ST22.

Hereinafter, until all of the completion flags are changed to ON, the recognition control unit 11 completes all of the procedures included in the list of the input sequence 3a.

Note that the above speech input process is an example and in the above process the dictionary generation unit 8 generates the speech recognition dictionary every time the procedure is executed, but the process is not limited thereto. For example, speech recognition dictionaries are collectively generated at the beginning, and the dictionary needed may be retrieved when needed and used in the speech recognition. Also, repeating the recognized value can be omitted. Alternatively, the process may include a confirmation process in which the system confirms the speech input user, “Is this OK?”, after repeating the recognition result, input is executed only in the case of OK, and, in the case of not OK, the procedure is re-executed from the speech of step ST26. In such a case, false value input due to false recognition can be prevented.

As described above, according to the first embodiment, the input-value-example acquisition unit 4 acquires one or more item(s) and the information about the value(s) of the input field(s) corresponding to one or more item(s), i.e., the input value example(s) from the form data 2a, which includes the input fields of speech input respectively for the items. The format estimation unit 6 estimates the input format of the input field based on the input value example. In this manner, by virtue of the configuration which estimates the input format of the input field based on the input value example of the input field, an appropriate input format can be determined even if a speech recognition specialist is not present.

More specifically, in a conventional case, the formats of the values which can be input are determined in advance, and speech recognition is carried out based on that. Generally, by carrying out speech recognition based on the input formats, and accuracy of the speech recognition can be enhanced, since the recognition result other than the input formats can be rejected. Therefore, it is important to set appropriate input formats.

However, in the conventional case, it is difficult for a worker who is not a speech recognition specialist to determine appropriate input formats, and setting appropriate input formats for all of input items takes extremely long time.

On the other hand, according to the first embodiment, as described above, even if a speech recognition specialist is not present, appropriate input formats can be estimated. Note that the information about the values of the input fields is not limited to input value examples, but may be a later-described format configuration. Also in a case with such implementation, effects similar to the above described effects can be obtained.

Also, according to the first embodiment, the input sequence 3a for inputting values in the plurality of input fields included in the form data 2a are retained in the input sequence storage unit 3. The input sequence 3a include the identifiers, which identify the input fields of the input target items included in the form data 2a, and the estimated input formats. Therefore, in addition to the above described effects, the input sequence 3a can be managed separately from the form data 2a. Note that the input sequence 3a are not limited to be retained in the memory of the information processing apparatus 1, but may be retained in a database apparatus which can communicate with the information processing apparatus 1 or may be retained in another sheet of the form data 2a. Also, the input sequence 3a may appropriately include procedure numbers, guidance, standard values, group names of procedures, etc. in addition to the identifiers and the input formats. Even with such modifications, the input sequence 3a can be managed separately from the form data 2a in the same manner as described above.

Also, according to the first embodiment, the range selection unit 5 selects a range of a plurality of input fields from the form data 2a. The input-value-example acquisition unit 4 acquires the input value examples corresponding to the input fields in the selected range. The format estimation unit 6 estimates the input format common to the input fields in the range based on the correspondingly acquired input value examples. Therefore, in addition to the above described effects, by virtue of the configuration which selects the range of the plurality of input fields, the labor hours of acquiring the input value examples can be reduced compared with a case where individual input fields are selected.

Moreover, according to the first embodiment, the dictionary generation unit 8 generates the speech recognition dictionary based on the estimated input format. The recognition control unit 11 executes speech recognition with respect to the speech of the user by using the speech recognition dictionary and inputs the text of the obtained speech recognition result in the input field in accordance with the identifier of the input field. Therefore, in addition to the above described effects, speech input with respect to the speech of the user can be executed.

Moreover, according to the first embodiment, the information about the value of the input field is the input value example, which is an example of the value of the input field. The input-value-example acquisition unit 4 acquires the value as the input value example from at least one of the form data 2a, in which the value of the input field has been input in advance, and a user interface, which receives input of the value in the input field. Therefore, in addition to the above described effects, the input value examples can be acquired from various acquisition sources.

Moreover, according to the first embodiment, the format estimation unit 6 may estimate the input format for each of the input fields of the range and estimate one of the input formats among the estimated as a common input format. In such a case, in addition to the above described effects, for example, if one of the plurality of input formats includes the others, the input formats can be integrated by adopting the narrowest input format.

Moreover, according to the first embodiment, the format estimation unit 6 may estimate the input format for each of the input fields of the range and estimate the input format including a plurality of estimated input formats as a common input format. In such a case, in addition to the above described effects, the input format can be integrated, for example, by determining the input format so that all of the plurality of input formats is included.

Moreover, according to the first embodiment, the format estimation unit 6 adjusts the estimated input format based on the number of the correspondingly acquired input value examples. Therefore, in addition to the above described effects, if the selected range (the number of cells) is small, usability of the user can be maintained by slightly loosening the input format, for example, by increasing the digit count (allow +1 digit) of the input format.

Moreover, according to the first embodiment, the input sequence 3a may further include upper/lower limit values (standard values) indicating the range of the values of the input field. The format estimation unit 6 may adjust the estimated input format based on the upper/lower limit values included in the input sequence 3a. In such a case, the input format can be more appropriately estimated since adjustment such as correcting the input format to slightly loosen it can be carried out so as to satisfy the conditions of the upper/lower limit values.

Moreover, according to the first embodiment, the input sequence 3a further include the guidance about the speech input in the input field. The format check unit 7 checks the estimated input format based on the guidance. Therefore, in addition to the above described effects, by virtue of the configuration which checks the estimated input format by the guidance, the propriety of the estimated input format can be improved. For example, an invalid input format such as a case where the input format is not in a time format while the word of the guidance is “XX time” can be validated. Moreover, since the input formats of the input fields for the plurality of items are estimated based on the input value examples to check validity of the input formats, appropriate input formats can be set even if the user is not a speech recognition specialist, and the time taken for input sequence creation can be shortened compared with a case where input formats are manually examined.

Note that the format check unit 7 may check the input format by using a rule for format check. Alternatively, the format check unit 7 may be implemented as a learned model obtained by learning a model by using existing data. Herein, as the existing data, for example, a data set provided with input data, which includes input value examples and input formats estimated from the input value examples, and output data, which includes check results of the estimated input formats. Even with such modifications, the estimated input format can be checked, and the accuracy of the estimated input format can be therefore improved.

Also, according to the first embodiment, the format check unit 7 generates an input value example from the estimated input format, speech-synthesizes the generated input value example, and executes speech recognition, by using the speech recognition dictionary, with respect to the speech waveform data obtained by the speech synthesis. The format check unit 7 checks the validity of the estimated input format by judging whether the speech recognition result and the generated input value example match each other or not. Therefore, in addition to the above described effects, by virtue of the configuration which checks the validity of the estimated input format by the speech recognition, the accuracy of the estimated input format can be improved.

Moreover, according to the first embodiment, the format check unit 7 may categorize the situation of the non-matching case by judging whether a command has been detected from the text of the speech recognition result or not as a result of the judgement. In such a case, the validity of the input format can be checked by depending on the presence or the absence of command false detection.

Moreover, according to the first embodiment, the format check unit 7 checks the input format by calculating the recognition accuracy or recognition error rate of the speech recognition based on the judged results. For example, the recognition error rate may be calculated by dividing the results judged as false recognition by the number of judgements, which is the number of the input value examples. Alternatively, a recognition accuracy may be calculated by dividing the results judged as successful recognition by the number of judgements, which is the number of the input value examples. In such a case, in addition to the above described effects, the validity of the input format can be statistically checked.

Moreover, according to the first embodiment, the format check unit 7 provides a notification about the result of checking the input format. Therefore, in addition to the above described effects, by virtue of the configuration which notifies the user of whether the situation of speech recognition failure is due to command false detection or not, the user can be prompted to take an appropriate measure in accordance with the situation of speech recognition failure. Note that this does not impose a limitation, and the format check unit 7 may notify the user of the fact that a recognition accuracy can be low and may notify the user of a factor(s) of the low recognition accuracy (conflict with command, procedure with low recognition accuracy, frequently mistaken characters, etc.). For example, the user may be notified of examples of homophones such as “9 (kyu)” and “Q (kyu)”. Also in this manner, the user can be prompted to take an appropriate measure in accordance with the situation of speech recognition failure.

Moreover, according to the first embodiment, if a command is falsely detected, the format check unit 7 may change a voice command. In such a case, since the conflict with the command can be solved by changing the word of the command, an unexpected situation due to command false detection can be avoided.

Moreover, according to the first embodiment, the display unit 12 may display the form data 2a and display the estimated input format in the input field included in the form data 2a. Similarly, the display unit 12 may generate one or more input value example(s) from the estimated input format and display the generated input value example(s) in the input field included in the form data 2a. Moreover, similarly, the display unit 12 may generate a range of values, which can be input in the input field, from the estimated input format and display the generated range in the input field included in the form data 2a. Therefore, in addition to the above described effects, since the estimated input format and the input value example generated from the input format are displayed on the form data 2a, input positions and the input format/the input value example on the form data 2a can be browsed and confirmed. Accordingly, the estimated input format can be displayed with the form with high browsability, and the input format can be automatically checked.

More specifically, conventionally, browsability is low since the input format and the input target item are separately displayed even after the input format is determined, and it is difficult to determine whether the set input format is actually appropriate or not by taking a look at the input format. Therefore, in the conventional case, an actual inputting attempt has to be made to check whether the input format is appropriate or not, and further time is taken.

On the other hand, according to the first embodiment, for example, as illustrated in FIG. 12, browsability is high since the input format and the input target item are closely displayed, and whether the set input format is appropriate or not can be easily determined by taking a look at the input format.

Moreover, according to the first embodiment, the input sequence 3a include the identifiers for identifying the fields of the input target items included in the form data 2a, the estimated input format, and the order of procedures (procedure numbers) for inputting values in the plurality of input fields included in the form data 2a. The display unit 12 displays the form data 2a and, overlays the order of inputting values in the plurality of input fields included in the form data 2a based on the input sequence 3a. Therefore, in addition to the above described effects, the user can visually confirm whether the order of input has been correctly set or not. Note that this does not impose a limitation, and the display unit 12 may overlay the information (guidance, standard values) in the input sequence 3a on the form data 2a. By virtue of this, similarly to the above description, the user can visually confirm whether the information (guidance, standard values) in the input sequence 3a has been correctly set or not.

### <Second Embodiment>

In the first embodiment, the range selection unit 5 selects the range for estimating an input format on the form data 2a in response to operation by an input sequence creator. On the other hand, in a second embodiment, a range selection unit 5 automatically selects the range, thereby automatically carrying out all of the operation of estimating an input format of the selected range and setting in input sequence 3a. In other words, different from the first embodiment, the range selection unit 5 automatically estimates a plurality of ranges for which the same input procedure is to be set.

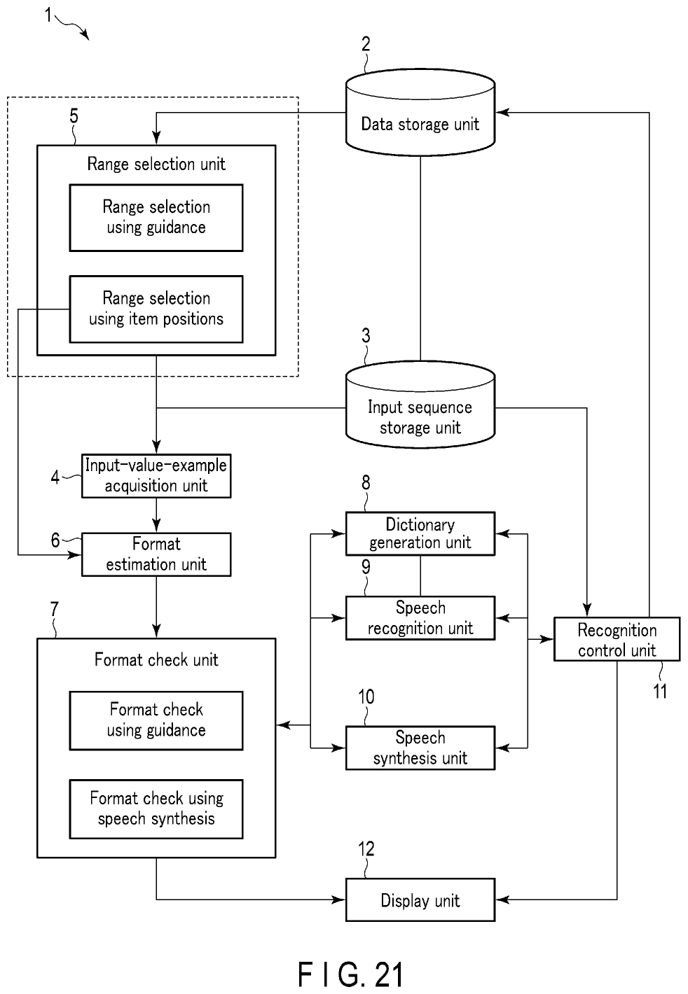

Accordingly, as illustrated in FIG. 21, in addition to the above-described feature, the range selection unit 5 executes at least one of range selection using guidance in the input sequence 3a and range selection using positions of input target items in the input sequence 3a.

The range selection unit 5 selects the range of input fields based on guidance, for example, by selecting the range of the input fields corresponding to guidance with the same words. Specifically, the range selection unit 5 may select, as one range, the range of the input fields corresponding to the same guidance included in the input sequence 3a.

In the case of the range selection using the item positions, the range selection unit 5 selects the range of the input fields based on a situation in which identifiers of the input fields of the input target items indicate close positions. Specifically, if the identifiers of the input target items included in the input sequence 3a indicate adjacent input fields, the range selection unit 5 may select the range of the input fields identified by the identifiers as one range. However, only if input value examples are acquired from the input fields of the input target items, if the input format is estimated for one of the input value examples by a format estimation unit 6, and if N or more input fields having the same input format are mutually adjacent, the input fields are preferred to be included in the range of the input fields (N is a predetermined threshold value).

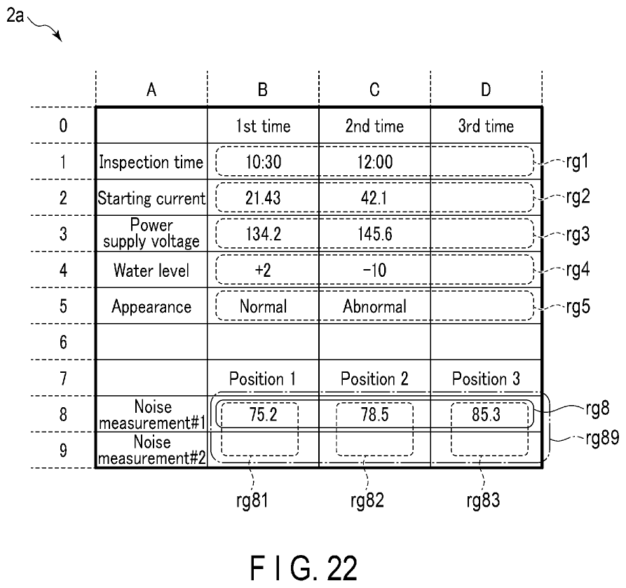

FIG. 22 illustrates form data 2a, input value examples, a list of input sequence, and ranges selected based on them. For example, each of B1 to D1, B2 to D2, . . . , B5 to D5 has common guidance (“inspection time”, “starting current”, . . . , “appearance”, respectively) and is therefore one range, i.e., rg1, rg2, . . . , rg5.

Regarding B8 to D9, since each of B8 to B9, C8 to C9, and D8 to D9 has the same guidance (“noise, position 1”, . . . , “noise, position 3”), each of rg81, . . . , rg83 is one range as illustrated by dashed lines. Furthermore, since the items of decimal_2_1 as the input format estimated from the already-input input value examples are B8 to D8,which are mutually adjacent, B8 to D9 all together is one range rg89 as illustrated by a dash-dotted line.

Other configurations are the same as those of the first embodiment.

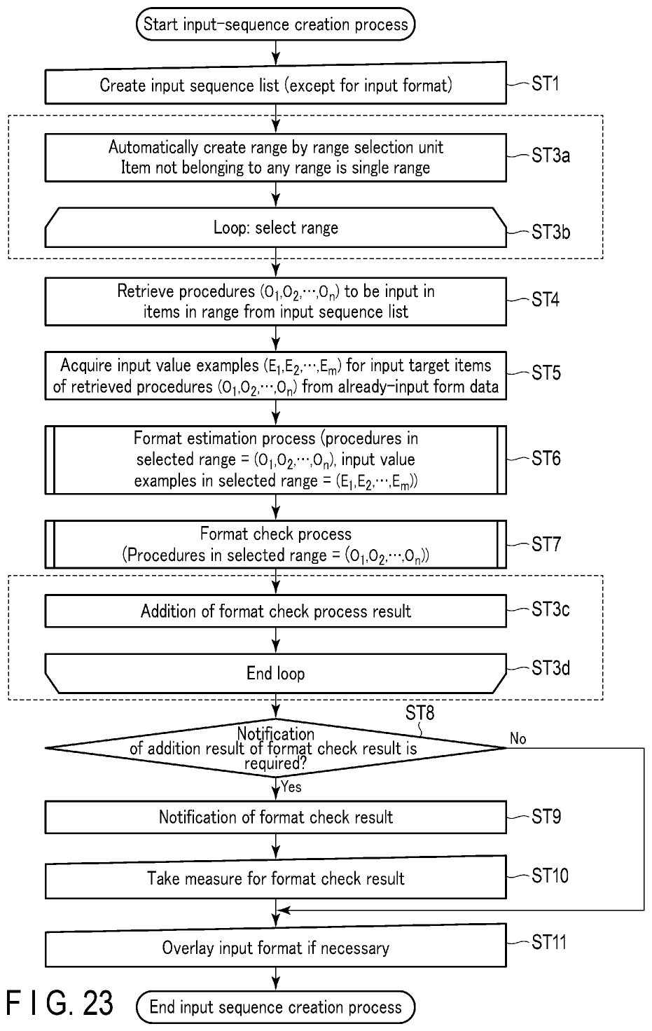

Next, operation of an information processing apparatus built in the above-described manner will be described by using a flow chart of FIG. 23.

At this point, similarly to the above, step ST1 of creating input sequence except for input formats is executed.

After step ST1, in step ST3a, the range selection unit 5 selects a range of input fields, for example, based on guidance. Also, the range selection unit 5 selects the range of the input fields, for example, based on the identifiers of the input target items included in the input sequence 3a. Specifically, for example, if the identifiers of the input target items indicate adjacent input fields, the range selection unit 5 selects the range of the adjacent input fields. In this process, the input target item corresponding to the input field not belonging to any range is a range having a single item.

After step ST3a, a loop process for the selected range (selected range) is executed between step ST3b and step ST3d. The loop process includes steps ST4 to ST7 similar to those described above and step ST3c.

Step ST4 is a process of retrieving a procedure in the selected range from the input sequence 3a.

Step ST5 is a process of acquiring the input value example of the retrieved procedure from the form data 2a.

Step ST6 is a process of estimating the input format from the acquired input value example.

Step ST7 is a process of checking the estimated input format.

After step ST7, in step ST3c, the format estimation unit 6 adds a format check process result without providing a notification at this point even if the notification of the result of the format check is required. More specifically, the format estimation unit 6 carries out addition of the number of command false detections and the number of false recognitions in the format check process and merges false recognition lists.

After the loop process for each range, a format check unit 7 executes steps ST8 and ST9 similarly to the above description. As a result, the format check unit 7 references an addition result of the format check process and, in accordance with presence/absence of command false detection and whether a recognition error rate is equal to or higher than a threshold value, provides a notification to an input sequence creator from a display unit 12 (step ST9).

Thereafter, similarly to the above description, the process of step ST10 and a subsequent process are executed. Thus, the input sequence creation process is terminated.

As described above, according to the second embodiment, the input sequence 3a further include the guidance including item names of the input target items. The range selection unit 5 selects the range of the input fields based on the guidance or the input field identifiers. Therefore, in addition to the above described effects, since the range for which the same input format is to be set is automatically selected, the time taken for setting the input sequence 3a can be further shortened.

### <Third Embodiment>

In the first embodiment, an input format is estimated based on input value examples. On the other hand, in a third embodiment, an input format is estimated based on a format configuration for display, which is already set in form data 2a.

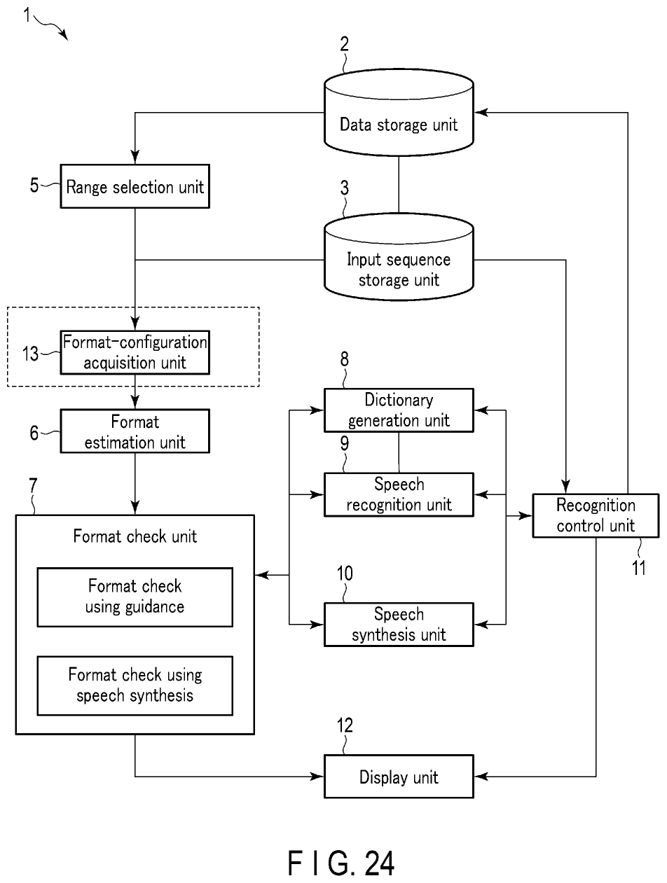

Accordingly, as illustrated in FIG. 24, an information processing apparatus 1 is provided with a format-configuration acquisition unit 13 instead of an input-value-example acquisition unit 4.

The format-configuration acquisition unit 13 acquires a format configuration of a selected range from the form data 2a. The format configuration is a configuration used to display values of input fields. As the format-configuration acquisition unit 13, for example, a function provided in an existing spreadsheet editing application can be used. For example, in Excel™, in a case where values are to be displayed in a format of cells (input fields), whether the values are to be displayed as numerical values, displayed as time and date, etc. can be selected. The format-configuration acquisition unit 13 is an example of an information acquisition unit which acquires a format configuration, which is included in data sheet for recording, as information about values of input fields.

On the other hand, a format estimation unit 6 estimates an input format based on the format configuration acquired instead of input value examples. For example, the format estimation unit 6 can pragramatically convert one format configuration to one input format. More specifically, for example, if the format is “Numerical value (the digit count after the decimal point is N)”, the input format thereof is “Decimal_1-_N”; and, if the format is “Date (2012 Mar. 14)”, the input format thereof is “Date year, month, day”. Since each item has one format configuration, one input format is obtained for each item. Then, integration of a plurality of input formats and adjustment in accordance with a selected range is executed in a manner like that of the first embodiment.

Other configurations are the same as those of the first embodiment.

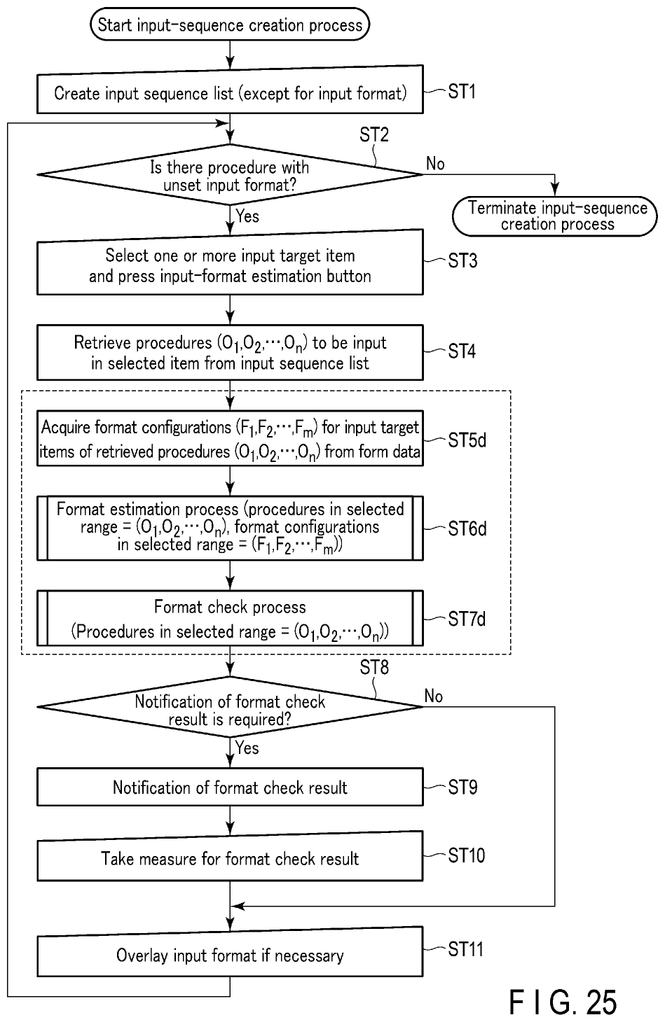

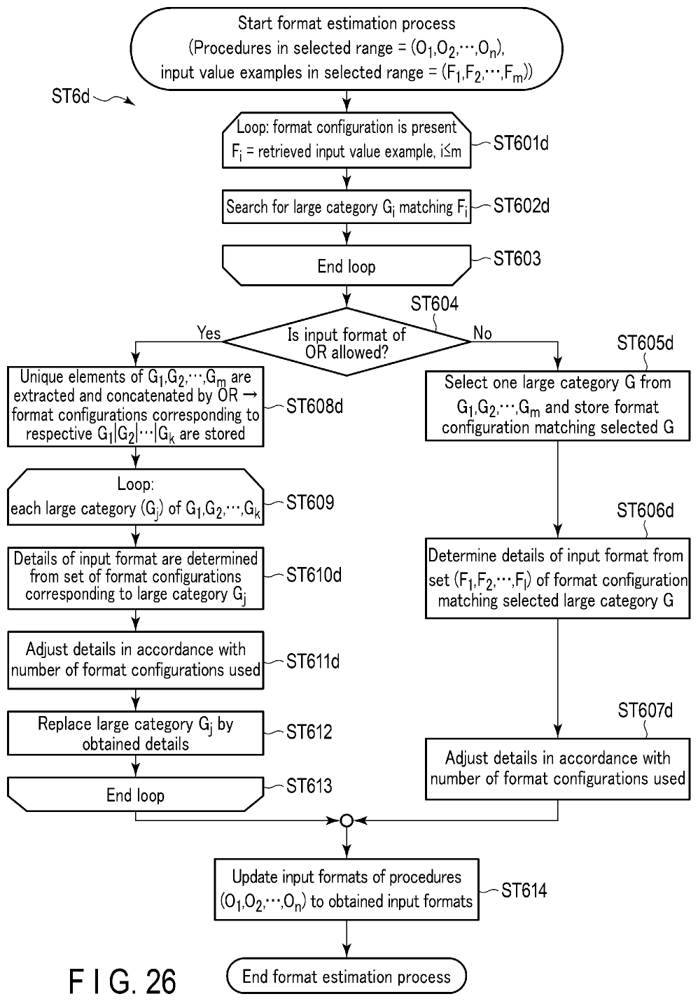

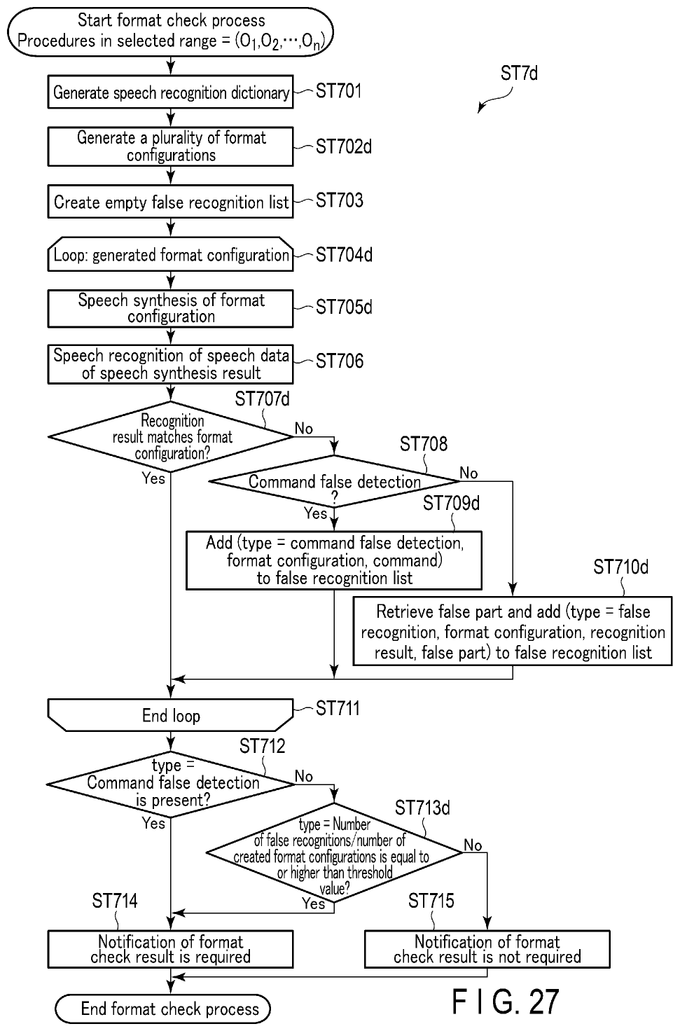

According to the above configuration, as illustrated in FIG. 25, FIG. 26, and FIG. 27, by using format configurations (F₁, F₂, . . . , Fₘ) instead of the input value examples (E₁, E₂, . . . , Eₘ), an input-sequence creation process, a format estimation process, and a format check process are executed similarly to the above.

As described above, according to the third embodiment, in the form data 2a, the information about the value of the input field of speech input is the format configuration used to display the value of the input field. The format-configuration acquisition unit 13 acquires the format configuration, which is included in the form data 2a, as the information about the value of the input field of speech input. Therefore, in addition to the above described effects, input value examples are not required to be separately prepared.

Note that, in the third embodiment, instead of the input value example, which is an example of the value of the input field, the format configuration used to display the value of the input field is acquired from the form data 2a, but the third embodiment is not limited thereto. For example, in third embodiment, the format-configuration acquisition unit 13 may acquire information including the input value example and the format configuration from the form data 2a. In such a case, the format-configuration acquisition unit 13 is an example of an information acquisition unit which acquires the information (information about the value of the input field) including the input value example and the format configuration from recording data sheet. According to such a modification example, working effects of the first and third embodiments can be obtained at the same time.

### <Fourth Embodiment>

In addition to the first embodiment, a fourth embodiment presents an actual operation example to an input sequence creator in order to confirm if a set input sequence works correctly.

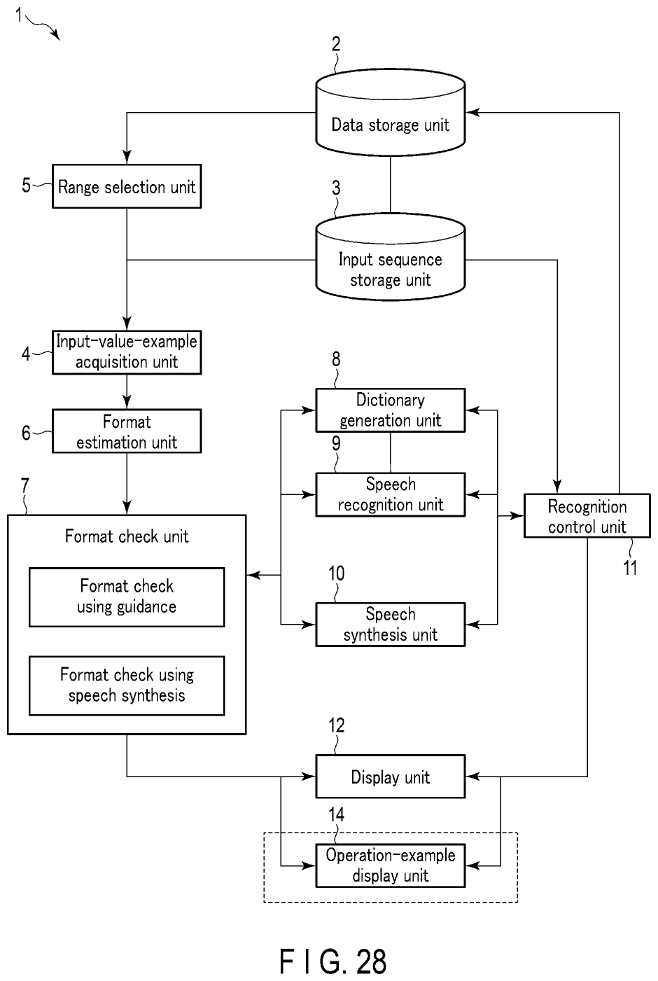

Accordingly, as illustrated in FIG. 28, an information processing apparatus 1 is further provided with an operation-example display unit 14 in addition to the configuration illustrated in FIG. 1.

Herein, the operation-example display unit 14 displays the operation example by automatically generating an input value example and automatically generating speech data by using speech synthesis instead of carrying out speech input spoken by a speech input user. More specifically, the operation-example display unit 14 generates an input value example from an estimated input format, subjects the generated input value example to speech synthesis, and provides speech waveform data to a recognition control unit 11 instead of speech of a user, thereby displaying the operation example of speech input by the recognition control unit 11. The operation example may be saved as a video and displayed by playing video or may be displayed by overlay on form data 2a. The operation-example display unit 14 overlays the operation examples on the form data 2a and then, in response to operation by the input sequence creator, collectively deletes the values input in the form data 2a as the operation examples.

Other configurations are the same as those of the first embodiment.

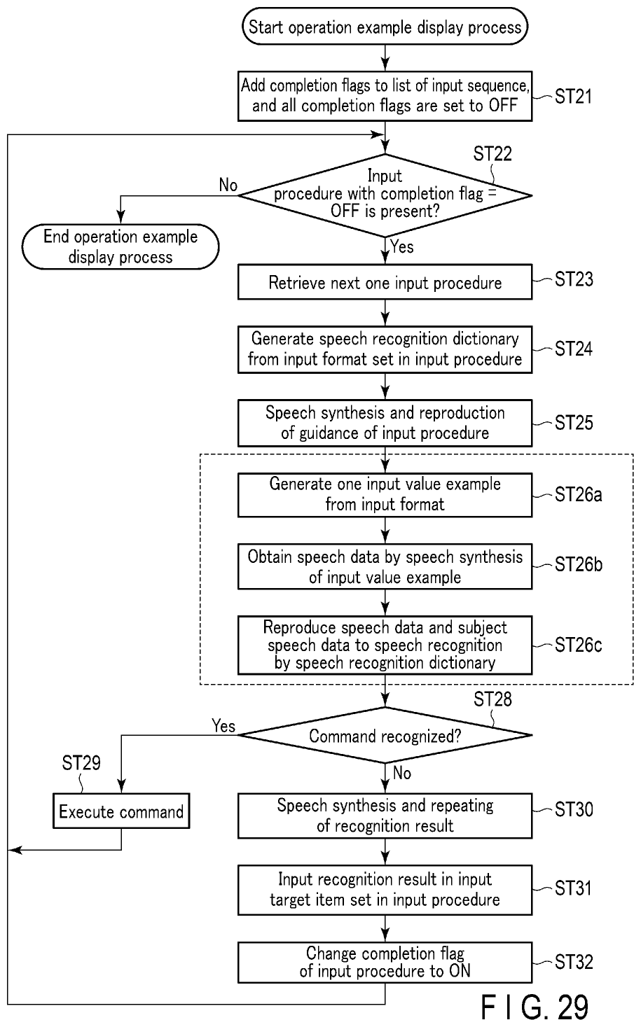

Next, operation of an information processing apparatus built in the above described manner will be described by using FIG. 29. This operation is different in a point that one input value example is automatically generated from an input format and is subjected to speech synthesis and that the synthesized speech waveform data is read aloud and subjected to speech recognition instead of the speech by the user and the speech recognition (steps ST26, ST27) in the speech input process illustrated in FIG. 20. The operation will be described below in order.

Steps ST21 to ST25 are executed in a manner like the above description.

After step ST25, in step ST26a, the operation-example display unit 14 generates the input value example from the estimated input format.

In step ST26b, the operation-example display unit 14 subjects the generated input value example to speech synthesis and obtains speech data.

In step STS26c, the operation-example display unit 14 provides the obtained speech data to the recognition control unit 11. The recognition control unit 11 executes speech recognition by using the speech recognition dictionary and inputs the text of the obtained speech recognition result in an input field in accordance with an identifier, which identifies the input field of an input target item. The operation-example display unit 14 displays the operation example of the speech input by the recognition control unit 11 in this manner by providing the speech data to the recognition control unit 11.

Thereafter, similarly to the above description, the process of step ST28 and a subsequent process are executed.

As described above, according to the fourth embodiment, the operation-example display unit 14 generates the input value example from the estimated input format, subjects the generated input value example to speech synthesis, and provides the speech data, which has been obtained by the speech synthesis, to the recognition control unit 11 instead of speech of the user, thereby displaying the operation example of the speech input by the recognition control unit 11. Therefore, in addition to the effects of the first embodiment, whether the input sequence is appropriate or not can be easily confirmed since the manner of operation of the set input sequence is displayed by the actual operation example.

### <Fifth Embodiment>

A fifth embodiment is a specific example of the above embodiments and modification examples and is an embodiment realizing the above described information processing apparatus 1 by a computer. The information processing apparatus 1 may be realized either by a general-purpose computer such as a personal computer or a dedicated computer such as an inspection apparatus (built-in system).

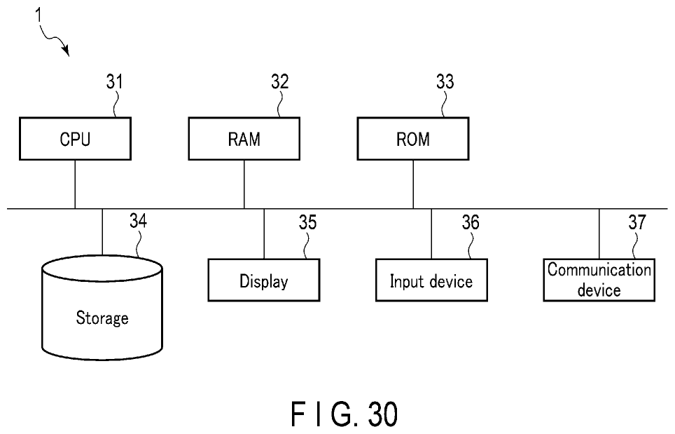

FIG. 30 is a block diagram exemplifying a hardware configuration of an information processing apparatus 1 according to the fifth embodiment. The information processing apparatus 1 includes a central processing unit (CPU) 31, a random access memory (RAM) 32, a read only memory (ROM) 33, a storage 34, a display 35, an input device 36, and a communication device 37, all of which are connected by a bus.

The CPU 31 is a processor that executes, for example, a calculation process and a control process in accordance with programs. The CPU 31 uses a predetermined area of the RAM 362 as a working area and executes processes of the respective portions of the information processing apparatus 1 described above in cooperation with programs stored in the ROM 33, the storage 34, etc. The CPU 31 and the processors may be referred to as processing circuits.

The RAM 32 is a memory such as a synchronous dynamic random access memory (SDRAM). The RAM 32 functions as a working area of the CPU 31.

The ROM 33 is a memory storing programs and various information in a non-rewritable manner.

The storage 34 is a device that writes and reads data in and from a magnetic recording medium, such as a hard disc drive (HDD), a semiconductor storage medium such as a flash memory, a magnetically recordable storage medium such as an HDD, or an optically recordable storage medium. The storage 34 writes and reads data in and from a storage medium in accordance with control from the CPU 31. The storage 34 is an example of a memory of a computer.

The display 35 is a display such as a liquid crystal display (LCD). The display 35 displays various information based on a display signal from the CPU 31.

The input device 36 is an input device, such as a mouse and a keyboard. The input device 36 receives information input by a user as an instruction signal and outputs the instruction signal to the CPU 31.

The communication device 37 communicates with external equipment via a network in accordance with control from the CPU 31. The communication device 37 may be also referred to as a communication circuit.

The instructions included in the process sequences described in the aforementioned embodiments can be implemented based on a software program. A general-purpose computer system may store the program beforehand and read the program in order to attain the same effects as those achieved by control operation of the aforementioned information processing apparatus 1. The instructions in the embodiments described above are stored, as a program executable by a computer, in a magnetic disc (flexible disc, hard disc, etc.), an optical disc (CD-ROM, CD-R, CD-RW, DVD-ROM, DVD±R, DVD±RW, Blu-ray (registered trademark) disc, etc.), a semiconductor memory, or a similar non-transitory storage medium. As long as the storage medium is readable by a computer or by a built-in system, any storage format can be used. The storage medium may be also referred to as a non-transitory computer readable storage medium. An information processing method with an operation similar to the control of the information processing apparatus 1 of the embodiments described above can be realized if a computer reads a program from the storage medium and executes the instructions written in the program on the CPU based on the program. For example, the information processing method includes acquiring one or more item(s) and information about a value of an input field corresponding to the one or more item(s) from form data 2a, which includes the input fields of speech input respectively for the items, and estimating an input format of the input field based on the information. The computer may, of course, acquire or read the program by way of a network.

In addition, an operating system (OS) working on a computer, database management software, middleware (MW) of a network, etc. may execute part of the processes to realize the present embodiment based on instructions of a program installed from a storage medium onto a computer and a built-in system.

Furthermore, the storage medium according to the present embodiment is not limited to a medium independent from a computer or a built-in system, but may include a storage medium storing or temporarily storing a program downloaded through a LAN or the Internet, etc.

Moreover, the number of storage media is not limited to one. The present embodiment includes the case where the process of the present embodiment is executed by means of a plurality of storage media, and the storage media can take any configuration.

The computer or built-in system in the present embodiments are used to execute each process in the present embodiments based on a program stored in a storage medium, and the computer or built-in system may be an apparatus including a PC, a microcomputer, or the like or may be a system or the like in which a plurality of apparatuses are connected through a network.

The computer adopted in the present embodiment is not limited to a PC, but generally refers to a calculation processing apparatus, a microcomputer, or the like included in an information processing apparatus or a device and apparatus that can realize the functions of the present embodiment by a program.

### (Modification Examples of Embodiments)

Note that embodiments and modification examples may be expressed as information processing methods or information processing programs including the steps of the above described information processing apparatus 1.

According to at least one of the above described embodiments, even if a speech recognition specialist is not present, appropriate input formats can be determined. The same applies to at least one of the above described modification examples.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A non-transitory computer readable storage medium including computer executable instructions, wherein the instructions, when executed by a processor, cause the processor to perform a method comprising:
acquiring one or more items and information about a value of an input field for the one or more items from a recording data sheet including the input field of speech input respectively for the items; and
estimating an input format of the input field based on the information.

2. The storage medium according to claim 1, wherein
an input sequence configured to input the values in the plurality of input fields included in the recording data sheet is retained in a memory of the computer, and
the input sequence includes an identifier configured to identify the input field of an input target item included in the recording data sheet and includes the estimated input format.

3. The storage medium according to claim 2, wherein
the method further comprises selecting a range of the plurality of input fields from the recording data sheet,
the acquiring includes acquiring the information correspondingly to the input field of the selected range, and
the estimating includes estimating the input format common to the input field of the range based on the correspondingly acquired information.

4. The storage medium according to claim 3, wherein
the input sequence further includes guidance including an item name of the input target item, and
the selecting includes selecting the range of the input field based on the guidance or the identifier.

5. The storage medium according to claim 2, wherein
the method further comprises
generating a speech recognition dictionary based on the estimated input format, and
executing speech recognition by using the speech recognition dictionary with respect to speech of a user, and inputting, in the input field, text of an obtained speech recognition result in accordance with the identifier.

6. The storage medium according to claim 1, wherein
the information is an input value example which is an example of the value of the input field, and
the acquiring includes acquiring the value as the input value example from at least one of the recording data sheet, which includes the value of the input field input in advance, and a user interface which receives input of the value in the input field.

7. The storage medium according to claim 1, wherein
the information is a format configuration which is used to display the value of the input field, and
the acquiring includes acquiring, as the information, the format configuration included in the recording data sheet.

8. The storage medium according to claim 1, wherein
the information includes an input value example which is an example of the value of the input field and includes a format configuration which is used to display the value of the input field, and
the acquiring includes acquiring the information including the input value example and the format configuration from the recording data sheet.

9. The storage medium according to claim 2, wherein
the method further comprises checking,
the input sequence further includes guidance about the speech input in the input field, and
the checking includes checking the estimated input format based on the guidance.

10. The storage medium according to claim 5, wherein the method further comprises
generating an input value example from the estimated input format, subjecting the generated input value example to speech synthesis, executing speech recognition by using the speech recognition dictionary with respect to speech data obtained by the speech synthesis, and checking the estimated input format by judging whether the text of the obtained speech recognition result matches the generated input value example or not.

11. The storage medium according to claim 1, wherein the method further comprises displaying the recording data sheet by a display and displaying the estimated input format in the input field included in the recording data sheet.

12. The storage medium according to claim 1, wherein the method further comprises generating one or more input value examples from the estimated input format and displaying the generated input value examples in the input field included in the recording data sheet by a display.

13. The storage medium according to claim 1, wherein the method further comprises generating a range of the value which can be input in the input field from the estimated input format and displaying the generated range in the input field included in the recording data sheet by a display.

14. The storage medium according to claim 1, wherein
the method further comprises displaying by a display,
an input sequence including an identifier which identifies the input field of an input target item included in the recording data sheet, the estimated input format, and an order of inputting the values in the plurality of input fields included in the recording data sheet is retained in a memory of the computer, and
the displaying by the display includes displaying the recording data sheet and overlaying, by the display, the order of inputting the values on the plurality of input fields included in the recording data sheet based on the input sequence.

15. An information processing apparatus comprising a processing circuit configured to
acquire one or more items and information about a value of an input field corresponding to the one or more items from a recording data sheet including the input field of speech input respectively for the items, and
estimate an input format of the input field based on the information.

16. An information processing method comprising:
acquiring one or more items and information about a value of an input field corresponding to the one or more items from a recording data sheet including the input field of speech input respectively for the items; and
estimating an input format of the input field based on the information.
